(19) United States
(12) Patent Application Publication
(10) Pub. No.: US 2022/0412763 A1
(43) Pub. Date: Dec. 29, 2022

(54) INFORMATION PROCESSING DEVICE, INFORMATION PROCESSING METHOD, AND PROGRAM

(71) Applicant: SONY GROUP CORPORATION, TOKYO (JP)

(72) Inventors: SHIN TAKANASHI, TOKYO (JP); MASAO ERIGUCHI, TOKYO (JP)

(21) Appl. No.: 17/780,729

(22) PCT Filed: Oct. 21, 2020
(86) PCT No.: PCT/JP2020/039510

§ 371 Date: May 27, 2022

(30) Foreign Application Priority Data
Dec. 5, 2019 (JP) 2019-220198

(51) Int. Cl. G01C 21/36; G06T 19/00

(52) U.S. Cl. CPC G01C 21/3638; G06T 19/006; G01C 21/3679

(57) ABSTRACT

A configuration is achieved in which display data selected on the basis of characteristic information acquired while a vehicle is traveling is displayed on a display unit inside the vehicle. The configuration has a data processing unit that executes display control of data output to the display unit provided inside a mobile device. The data processing unit acquires characteristic information while the mobile device is traveling, and decides, on the basis of the acquired characteristic information, display data to be output to the display unit. The data processing unit selects display data recorded corresponding to the acquired characteristic information from a characteristic-information corresponding display data storage database, generates an AR image obtained by superimposing the selected display data on a real object image that is an image captured by a camera mounted on the mobile device, and outputs the AR image to the display unit.

### TECHNICAL FIELD

The present disclosure relates to an information processing device, an information processing method, and a program. More specifically, the present disclosure relates to an information processing device, an information processing method, and a program that execute display control of an output image of a display unit installed on an inner surface of a mobile device, and processing to which a display image is applied.

### BACKGROUND ART

Recent vehicles such as passenger cars are equipped with a display apparatus such as a car navigation system that presents travel path information or traffic information, and thus various kinds of information can be provided to drivers and occupants by utilizing a display apparatus.

For example, Patent Document 1 (Japanese Patent Application Laid-Open No. 2017-037077) discloses conventional technology in which a message is provided to a driver or an occupant by utilizing a display apparatus.

This patent document discloses a configuration in which information of a location of a speed measurement device installed on a road is acquired, and in a case where it is detected that a vehicle is approaching a location where the speed measurement device is installed, warning display for notifying a driver that the speed measurement device is approaching, which is for example, animation display of a character, or the like is performed.

However, most of display devices mounted on conventional vehicles merely display route information, traffic information, or warning as described above.

### CITATION LIST

### Patent Document

Patent Document 1: Japanese Patent Application Laid-Open No. 2017-037077

### SUMMARY OF THE INVENTION

### Problems to be Solved by the Invention

An object of the present disclosure is to provide an information processing device, information processing method, and program for displaying, for a driver or occupant, information selected according to travel environment of a vehicle, which is, for example, information of content, a message, or the like selected corresponding to a characteristic of a travel path, a store on the travel path, or the like.

### Solutions to Problems

A first aspect of the present disclosure is

an information processing device including a data processing unit that executes display control of data output to a display unit provided inside a mobile device,

in which the data processing unit acquires characteristic information while the mobile device is traveling, and decides, on the basis of the acquired characteristic information, display data to be output to the display unit.

Moreover, a second aspect of the present disclosure is an information processing method executed in an information processing device,

in which the information processing device includes a data processing unit that executes display control of data output to a display unit provided inside a mobile device, and

the data processing unit acquires characteristic information while the mobile device is traveling, and decides, on the basis of the acquired characteristic information, display data to be output to the display unit.

Moreover, a third aspect of the present disclosure is a program that causes information processing to be executed in an information processing device,

in which the information processing device includes a data processing unit that executes display control of data output to a display unit provided inside a mobile device, and

the program causes the data processing unit to acquire characteristic information while the mobile device is traveling, and to decide, on the basis of the acquired characteristic information, display data to be output to the display unit.

Note that a program according to the present disclosure is, for example, a program that can be provided by a storage medium or communication medium provided in a computer-readable format to an information processing device or computer system capable of executing various program codes. By providing such a program in the computer-readable format, processing according to the program is achieved on the information processing device or the computer system.

Still other objects, features, and advantages of the present disclosure will be apparent from more detailed description based on an embodiment of the present disclosure described later and the accompanying drawings. Note that, in the present specification, a system is a logical set configuration of a plurality of devices, and is not limited to a system in which devices of respective configurations are in the same housing.

According to a configuration of an embodiment of the present disclosure, a configuration is achieved in which display data selected on the basis of characteristic information acquired while a vehicle is traveling is displayed on a display unit inside the vehicle.

Specifically, for example, the configuration has a data processing unit that executes display control of data output to the display unit provided inside the mobile device. The data processing unit acquires characteristic information while the mobile device is traveling, and decides, on the basis of the acquired characteristic information, display data to be output to the display unit. The data processing unit selects display data recorded corresponding to the acquired characteristic information from a characteristic-information corresponding display data storage database, generates an AR image obtained by superimposing the selected display data on a real object image that is an image captured by a camera mounted on the mobile device, and outputs the AR image to the display unit.

With this configuration, a configuration is achieved in which display data selected on the basis of characteristic information acquired while a vehicle is traveling is displayed on a display unit inside the vehicle.

Note that the effects described herein are only examples and are not limited thereto, and additional effects may also be present.

### BRIEF DESCRIPTION OF DRAWINGS

FIG. 1 is a diagram describing a configuration example of a vehicle.

FIG. 2 is a diagram describing a configuration example of an inside of the vehicle.

FIG. 3 is a diagram describing a characteristic-information setting map.

FIG. 4 is a diagram describing an example of display data on a display unit inside the vehicle.

FIG. 5 is a diagram describing an example of display data on a display unit inside the vehicle.

FIG. 6 is a diagram describing an example of data stored in the characteristic-information corresponding display data storage database.

FIG. 7 is a diagram illustrating a flowchart describing a processing sequence of Example 1 of the information processing device according to the present disclosure.

FIG. 8 is a diagram illustrating a configuration example of Example 1 of the information processing device according to the present disclosure.

FIG. 9 is a diagram illustrating a flowchart describing a processing sequence of Example 2 of the information processing device according to the present disclosure.

FIG. 10 is a diagram describing an example of data stored in a characteristic-scene corresponding display data storage database.

FIG. 11 is a diagram illustrating a configuration example of Example 2 of the information processing device according to the present disclosure.

FIG. 12 is a diagram describing a configuration example of generation of an averaged 3D map executed in Example 2 of the information processing device according to the present disclosure.

FIG. 13 is a diagram illustrating a configuration example of Example 2 of the information processing device according to the present disclosure, the configuration example utilizing the averaged 3D map.

FIG. 14 is a diagram describing an example of characteristic information utilized in Example 3 of the information processing device according to the present disclosure.

FIG. 15 is a diagram illustrating a flowchart describing a processing sequence of Example 3 of the information processing device according to the present disclosure.

FIG. 16 is a diagram illustrating a configuration example of Example 3 of the information processing device according to the present disclosure.

FIG. 17 is a diagram illustrating a flowchart describing a processing sequence of Example 4 of the information processing device according to the present disclosure.

FIG. 18 is a diagram illustrating a configuration example of Example 4 of the information processing device according to the present disclosure.

FIG. 19 is a diagram illustrating a flowchart describing a processing sequence of Example 5 of the information processing device according to the present disclosure.

FIG. 20 is a diagram illustrating a configuration example of Example 5 of the information processing device according to the present disclosure.

FIG. 21 is a diagram illustrating a configuration example of an information processing system.

FIG. 22 is a diagram describing a hardware configuration example of the information processing device.

### MODE FOR CARRYING OUT THE INVENTION

Hereinafter, an information processing device, information processing method, and program according to the present disclosure will be described in detail with reference to the drawings. Note that the description will be made according to the following items.

1. Configuration example of vehicle equipped with display unit on which display control is performed by information processing device according to present disclosure

2. Example of display information control processing executed by information processing device according to present disclosure

2-1. (Example 1) Example of performing display information control in which image corresponding to characteristic information set in characteristic-information setting map is output by utilizing characteristic-information setting map corresponding to travel route from departure place to destination

2-2. (Example 2) Example of performing, during travel on travel route from departure place to destination, display information control in which characteristic scene is extracted from image captured by camera that captures image of outside of vehicle, and image corresponding to extracted characteristic scene is output

2-3. (Example 3) Example of performing, during travel on travel route from departure place to destination, display information control in which display data is decided on basis of detection information from various kinds of sensors, such as camera, and other acquired information, and decided display data is output

2-4. (Example 4) Example of performing display information control in which image corresponding to characteristic information set in characteristic-information setting map is output by utilizing characteristic-information setting map corresponding to travel route from departure place to destination, and performing travel control of vehicle according to characteristic information set in characteristic-information setting map

2-5. (Example 5) Example of performing display information control in which image selected according to characteristic information set in characteristic-information setting map or occupant attribute is output by utilizing characteristic-information setting map corresponding to travel route from departure place to destination, and performing switching control of display data on basis of occupant observation data

3. Configuration examples of information processing device and information processing system

4. Hardware configuration example of information processing device

5. Conclusion of configuration of present disclosure

[1. Configuration example of vehicle equipped with display unit on which display control is performed by information processing device according to present disclosure]

First, a configuration example of a vehicle equipped with a display unit on which display control is performed by an information processing device according to present disclosure will be described.

In recent years, development of autonomous driving vehicles has progressed, and it is predicted that a large number of autonomous driving vehicles will travel in the future.

In a fully autonomous driving vehicle, it is not necessary for a driver to drive looking ahead. Therefore, it is not necessary to provide a window such as a windshield in the autonomous driving vehicle, and it is possible to install a display unit (display) on what is known currently as a window area of a vehicle, and display various kinds of content on the display unit.

For example, it is also possible to display an image, which is captured by a camera mounted outside the vehicle, on a display unit inside the vehicle, and if such display processing is performed, an occupant of the vehicle can observe external scenery via the display unit, similarly to viewing the external scene though a window.

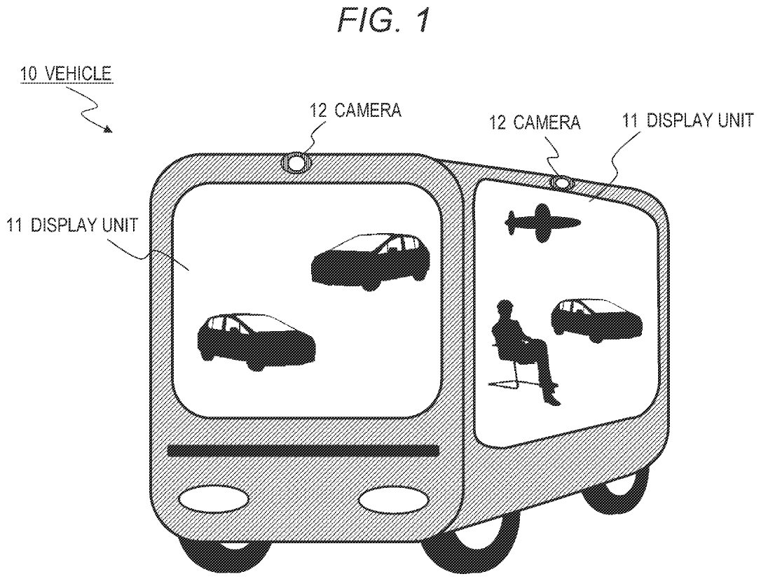

FIG. 1 is a diagram illustrating an example of external appearance of a vehicle 10 that is a mobile device according to the present disclosure.

The vehicle 10 is, for example, an autonomous driving vehicle, and it is not necessary to provide a window thereon. Therefore, a display unit can be provided both inside and outside the vehicle in an area corresponding to a window of a conventional vehicle. FIG. 1 illustrates the external appearance of the vehicle, and illustrates an example in which the display units 11 are provided on a front surface and side surface of the vehicle.

The vehicle 10 is provided with cameras 12, and an image captured by the cameras can be displayed on a display unit installed inside the vehicle 10.

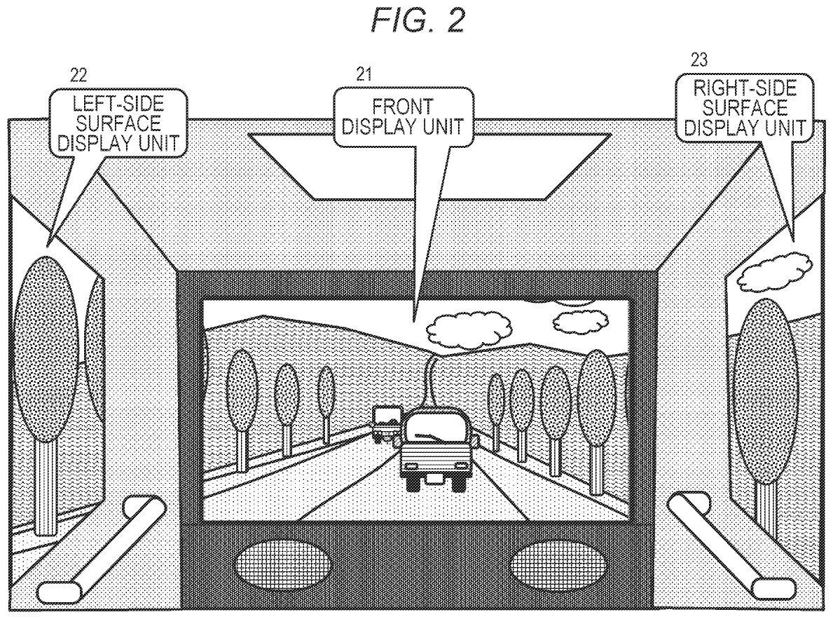

FIG. 2 is a diagram illustrating an example of an internal configuration of the vehicle 10 equipped with the information processing device according to the present disclosure.

Inside the vehicle 10, a front display unit 21 is provided on a front part, a left-side surface display unit 22 is provided on a left side surface, and a right-side surface display unit 23 is provided on a right side surface.

Note that, although not illustrated, a rear display unit can also be installed on a rear part of the vehicle 10.

For example, an image captured by an external camera that captures an image of a view ahead of the vehicle 10 is displayed on the front display unit 21.

For example, an image captured by an external camera that captures an image of a view from a left side of the vehicle 10 is displayed on the left-side surface display unit 22.

Furthermore, an image captured by an external camera that captures an image of a view from a right side of the vehicle 10 is displayed on the right-side surface display unit 23.

When such image display is performed, an occupant of the vehicle 10 can observe, via the display units 21 to 23, surrounding scenery that changes according to traveling of the vehicle 10, similarly to a conventional vehicle.

These display units 21 to 23 can display not only an image of external scenery captured by an external camera, but also various kinds of information such as various kinds of content and messages.

The information processing device that executes display control of the display unit mounted on the vehicle 10 is mounted inside the vehicle 10 or is configured as an external device capable of communicating with the vehicle 10.

For example, the information processing device executes display control processing of information selected according to travel environment of the vehicle 10, for example, information such as content or a message selected according to, for example, a characteristic around the travel path, a store around the travel path, or the like, that is a characteristic scene around the travel path.

Hereinafter, specific examples of processing executed by the information processing device according to the present disclosure will be described.

[2. Example of display information control processing executed by information processing device according to present disclosure]

Next, there will be described examples of processing by the information processing device according to the present disclosure, that is, the information processing device according to the present disclosure that executes display information control on the display unit of the vehicle 10 described with reference to FIGS. 1 and 2.

Note that, as described above, the information processing device according to the present disclosure that executes display information control on the display unit of the vehicle 10 described with reference to FIGS. 1 and 2 may be an information processing device mounted on the vehicle 10, or may be an external information processing device capable of communicating with the vehicle 10.

Hereinafter, the following five types of Examples will be sequentially described as specific examples of display information control processing executed by the information processing device according to the present disclosure.

(Example 1) Example of performing display information control in which image corresponding to characteristic information set in characteristic-information setting map is output by utilizing characteristic-information setting map corresponding to travel route from departure place to destination

(Example 2) Example of performing, during travel on travel route from departure place to destination, display information control in which characteristic scene is extracted from image captured by camera that captures image of outside of vehicle, and image corresponding to extracted characteristic scene is output

(Example 3) Example of performing, during travel on travel route from departure place to destination, display information control in which display data is decided on basis of detection information from various kinds of sensors, such as camera, and other acquired information, and decided display data is output

(Example 4) Example of performing display information control in which image corresponding to characteristic information set in characteristic-information setting map is output by utilizing characteristic-information setting map corresponding to travel route from departure place to destination, and performing travel control of vehicle according to characteristic information set in characteristic-information setting map

(Example 5) Example of performing display information control in which image selected according to characteristic information set in characteristic-information setting map or occupant attribute is output by utilizing characteristic-information setting map corresponding to travel route from departure place to destination, and performing switching control of display data on basis of occupant observation data

Hereinafter, these Examples will be sequentially described.

[2-1. (Example 1) Example of performing display information control in which image corresponding to characteristic information set in characteristic-information setting map is output by utilizing characteristic-information setting map corresponding to travel route from departure place to destination]

First, (Example 1) Example of performing display information control in which image corresponding to characteristic information set in characteristic-information setting map is output by utilizing characteristic-information setting map corresponding to travel route from departure place to destination will be described.

The information processing device according to the present disclosure utilizes a characteristic-information setting map corresponding to a travel route from a departure place to a destination place to perform display information control.

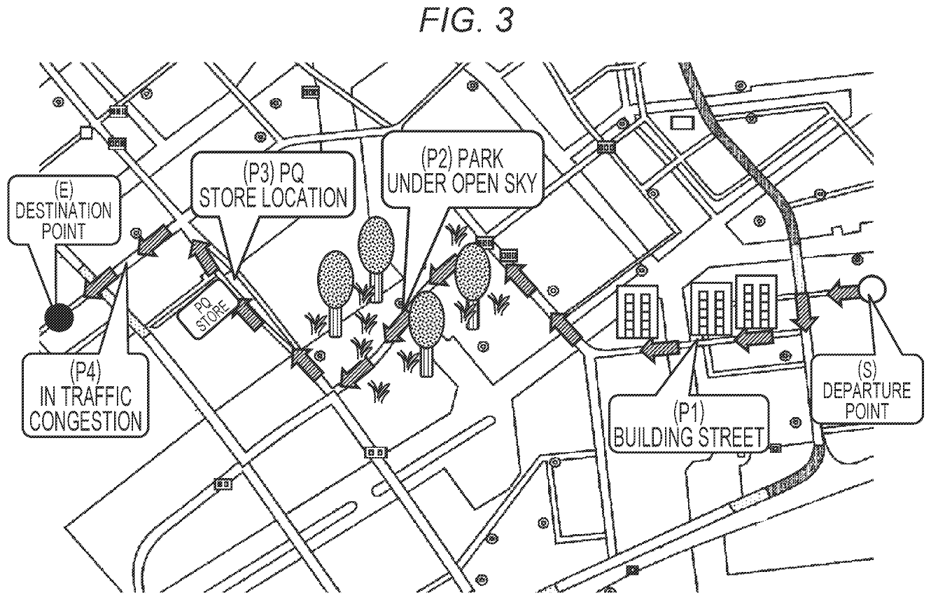

FIG. 3 is a diagram illustrating an example of a characteristic-information setting map utilized by the information processing device according to the present disclosure.

As illustrated in FIG. 3, the characteristic-information setting map is a map in which various pieces of characteristic information regarding a travel route from (S) Departure point to (E) Destination point of the vehicle 10 are recorded.

(S) Departure point and (E) Destination point are set by a user or manager of the vehicle 10, and for example, a shortest travel route is selected on the basis of settings for (S) Departure point and (E) Destination point. Alternatively, the user or manager of the vehicle 10 may decide a travel route of the vehicle.

The information processing device acquires characteristic information of each location on a decided travel route of the vehicle, and records the acquired characteristic information in association with the location on the map. By this processing, for example, a characteristic-information setting map as illustrated in FIG. 3 is generated.

Note that the characteristic-information setting map illustrated in FIG. 3 is an example of a characteristic-information setting map in which the following characteristic information is set at three places on the travel route.

(P1) Building street

(P2) Park under open sky

(P3) PQ Store location

(P4) In traffic congestion

Among characteristic information of (P1) to (P4), following characteristic information is characteristic information that does not greatly change over time, and is characteristic information that can be acquired in advance.

(P1) Building street

(P2) Park under open sky

(P3) PQ Store

Meanwhile, characteristic information

(P4) In traffic congestion

is characteristic information that changes over time, and is characteristic information that needs to be sequentially updated.

Thus, the characteristic information includes various types of different characteristic information.

The information processing device acquires these various different types of characteristic information from various kinds of information sources such as a storage unit in the information processing device or an external server, for example. For example, information acquisition processing as below is executed.

(1) Processing of acquiring characteristic information acquired by traveling processing of camera-mounted vehicle executed in advance and stored in storage unit of information processing device or external server

(2) Processing of acquiring real-time traffic-information provided by external traffic-information provision server

(3) Processing of acquiring real-time characteristic information (event information or the like) provided by external event-information provision server

“(1) Processing of acquiring characteristic information acquired by traveling processing of camera-mounted vehicle executed in advance and stored in storage unit of information processing device or external server” among the above can be executed as processing of acquiring, for example, either

(a) Information acquired in past by utilizing a self-vehicle having the configuration illustrated in FIGS. 1 and 2, and stored in a storage unit of the information processing device or the external server, or

(b) Information acquired by traveling processing of a camera-mounted vehicle other than the self-vehicle, and accumulated in an external server.

Furthermore, “(2) Processing of acquiring real-time traffic-information provided by external traffic-information provision server” among the above can be executed as information acquisition processing utilizing a local dynamic map (LDM) for example, other than as general traffic information acquisition processing.

The local dynamic map (LDM) is a map provided from an LDM provision server to an autonomous driving vehicle, for example, and includes a plurality of hierarchical information groups. Specifically, the map includes the following four different types of data.

Type 1 (static data)=Data such as map information updated in a medium to long term, for example.

Type 2 (semi-static data)=Data of an architectural structure such as a building, a tree, a sign board, or the like for example, the data not changing in a short term, but changing in a long term.

Type 3 (semi-dynamic data)=Data of a traffic light signal, traffic congestion, an accident, or the like, which may change in a certain unit of time.

Type 4 (dynamic data)=Sequentially changing data, such as traveling information regarding vehicle traffic congestion, a degree of human congestion, or the like.

A local dynamic map (LDM) including these data is transmitted from, for example, the LDM provision server to each vehicle.

Furthermore, “(3) Processing of acquiring real-time characteristic information (event information or the like) provided by external event-information provision server” among the above is, for example, processing of acquiring various pieces of information or the like of various kinds of events, such as, for example, a festival or concert, to be held.

These pieces of information can be acquired from, for example, the event-information provision server, or the like.

Thus, the information processing device according to the present disclosure executes the following information acquisition processing that is

(1) Processing of acquiring characteristic information acquired by traveling processing of camera-mounted vehicle executed in advance and stored in storage unit of information processing device or external server,

(2) Processing of acquiring real-time traffic-information provided by external traffic-information provision server, and

(3) Processing of acquiring real-time characteristic information (event information or the like) provided by external event-information provision server,

and generates a characteristic-information setting map on which characteristic information corresponding to each location on, for example, a vehicle travel route illustrated in FIG. 3 is recorded.

The information processing device according to the present disclosure generates, for example, the characteristic-information setting map illustrated in FIG. 3 by utilizing information acquired from various kinds of information sources, refers to the generated characteristic-information setting map, and executes display information on the display unit.

In a case where, while the vehicle 10 is traveling, the vehicle 10 approaches an area of which characteristic information is recorded on the characteristic-information setting map, the information processing device selects display data associated with the characteristic information of the area from the database, and displays the selected display data on the display unit inside the vehicle 10.

That is, display data selected on the basis of characteristic information corresponding to an area through which the vehicle passes is displayed on the front display unit 21, the left-side surface display unit 22, the right-side surface display unit 23, or the like provided inside the vehicle described above with reference to FIG. 2.

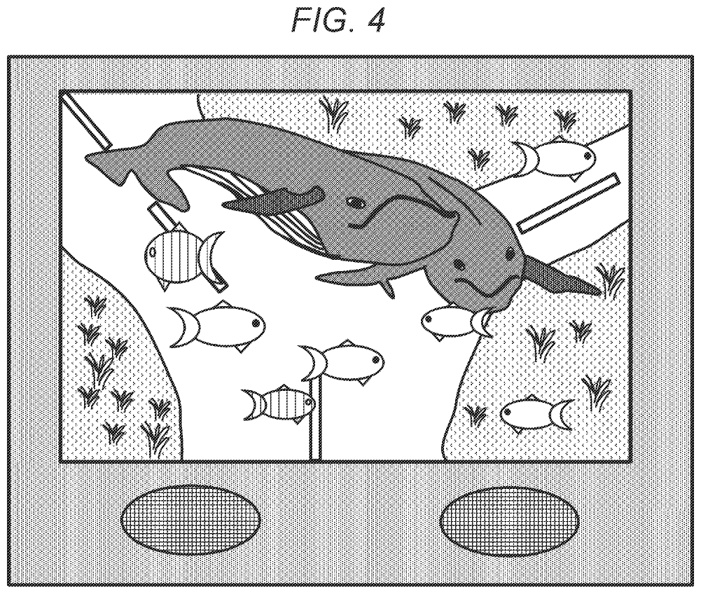

FIG. 4 illustrates an example of data displayed on the display unit inside the vehicle by display control by the information processing device according to the present disclosure.

The example illustrated in FIG. 4 is an example of display data in which “whales” and “fish” fly above a park.

The park in a background is an actual image of an outside of the vehicle 10, the actual image being captured by a camera outside the vehicle 10, that is, a camera 12 described with reference to FIG. 1.

Thus, for example, the information processing device according to the present disclosure generates and outputs an augmented reality (AR) image (=AR image) in which a virtual object such as a “whale” or “fish” is superimposed on a real object image captured by a camera.

An example of a display image illustrated in FIG. 4 is an example of display data displayed at a timing when the vehicle 10 approaches or passes through an area (a park under the open sky) for which characteristic information

(P2) Park under open sky

as in the characteristic-information setting map illustrated in FIG. 3 is set.

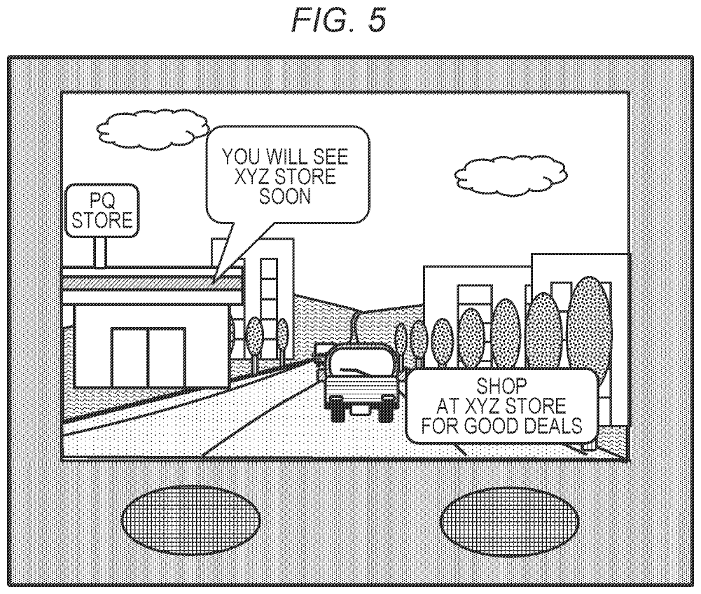

Another example of data displayed on the display unit inside the vehicle by display control by the information processing device will be illustrated in FIG. 5.

An example illustrated in FIG. 5 is an example of display data displayed at a timing when the vehicle 10 approaches or passes through an area for which characteristic information

(P3) PQ Store location

as in the characteristic-information setting map illustrated in FIG. 3 is set.

A background image of display information illustrated in FIG. 5 is an actual image of an outside of the vehicle 10, the actual image being captured by a camera outside the vehicle 10, that is, a camera 12 described with reference to FIG. 1.

When the “PQ store” appears on the actual image, the information processing device displays guidance information of a “XYZ store”, which is a competing store of the “PQ store”.
As illustrated in FIG. 5, messages such as “You will see XYZ store soon” and “Shop at XYZ store for good deals” are displayed.

This is an example of processing of displaying a message as advertisement information, and an advertisement fee is received from the “XYZ store” to display an advertisement of such a specific company.

As illustrated in FIG. 5, by outputting such an advertisement message at a timing when the vehicle is approaching a location of a competing shop, there is an effect of guiding a user who is likely to flow to the competing shop to a store of an own company.

Thus, the information processing device according to the present disclosure utilizes, for example, a characteristic-information setting map as described with reference to FIG. 3, selects display content or a display message on the basis of characteristic information associated with each area on the characteristic-information setting map, and displays the selected display data at a timing when the vehicle approaches or passes through the area for which the characteristic information is set.

In a case where the vehicle 10 approaches an area of which characteristic information is recorded on the characteristic-information setting map, the information processing device according to the present disclosure selects display data associated with the characteristic information of the area from the database (characteristic-information corresponding display data storage database), and displays the selected display data on the display unit inside the vehicle 10.

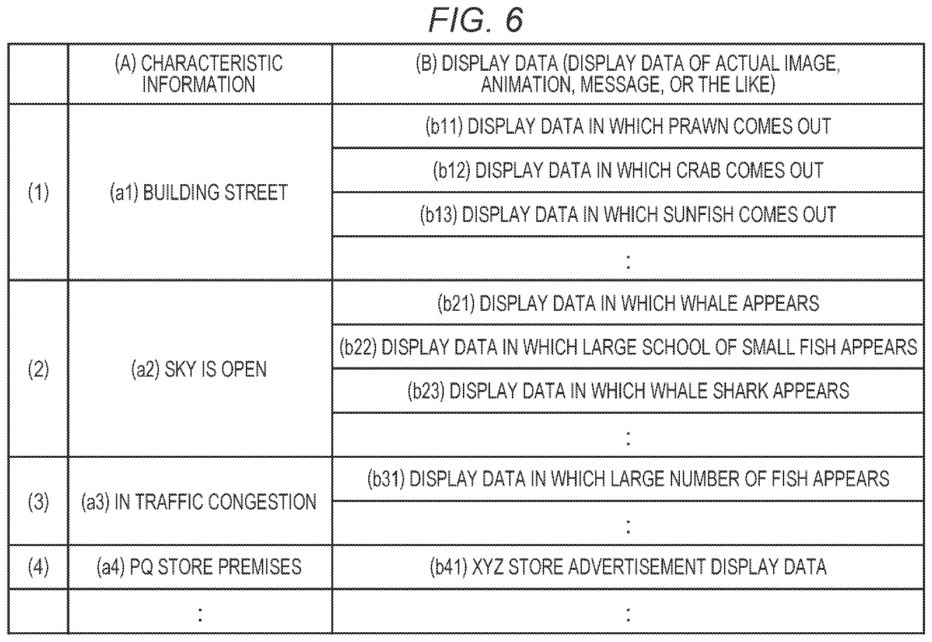

FIG. 6 illustrates an example of data recorded in a database (characteristic-information corresponding display data storage DB) utilized when the information processing device selects display data.

In the characteristic-information corresponding display data storage DB, display data associated with each piece of characteristic information is recorded.

Specifically, as illustrated in FIG. 6, data as below is associated and recorded.

(A) Characteristic information=(a1) Building street

(B) Display data

(b11) Display data in which prawn comes out

(b12) Display data in which crab comes out

(b13) Display data in which sunfish comes out

(A) Characteristic information=(a2) Sky is open

(B) Display data

(b21) Display data in which whale appears

(b22) Display data in which large school of small fish appears

(b23) Display data in which whale shark appears

(A) Characteristic information=(a3) In traffic congestion

(B) Display data

(b31) Display data in which large number of fish appears

(A) Characteristic information=(a4) PQ store premises

(B) Display data

(b41) XYZ store advertisement display data

The storage unit of the information processing device has, for example, the characteristic-information corresponding display data storage DB that stores corresponding data as illustrated in FIG. 6.

Note that data stored as (B) Display data in the characteristic-information corresponding display data storage DB is image data or animation data, that is, for example, video data of a captured image of a whale, animation image data, or image data for displaying a message image or the like.

The information processing device holds, in the storage unit, the characteristic-information corresponding display data storage DB in which characteristic information and display data are associated with each other. A data processing unit (display control unit) of the information processing device refers to the database, and selects and displays display data corresponding to characteristic information.

Note that actual image data or animation data may not be stored in the characteristic-information corresponding display data storage DB held by the information processing device, and access information (URL or the like) for acquiring actual image data or animation data from an external device may be recorded.

In this case, the information processing device performs processing of acquiring the actual image data or animation data from the external device by utilizing the access information (URL or the like).

Note that an entire characteristic-information corresponding display data storage DB may be held by an external device such as an external server for example, and the information processing device of the vehicle may access the external server to perform processing of acquiring the display data associated with the characteristic information.

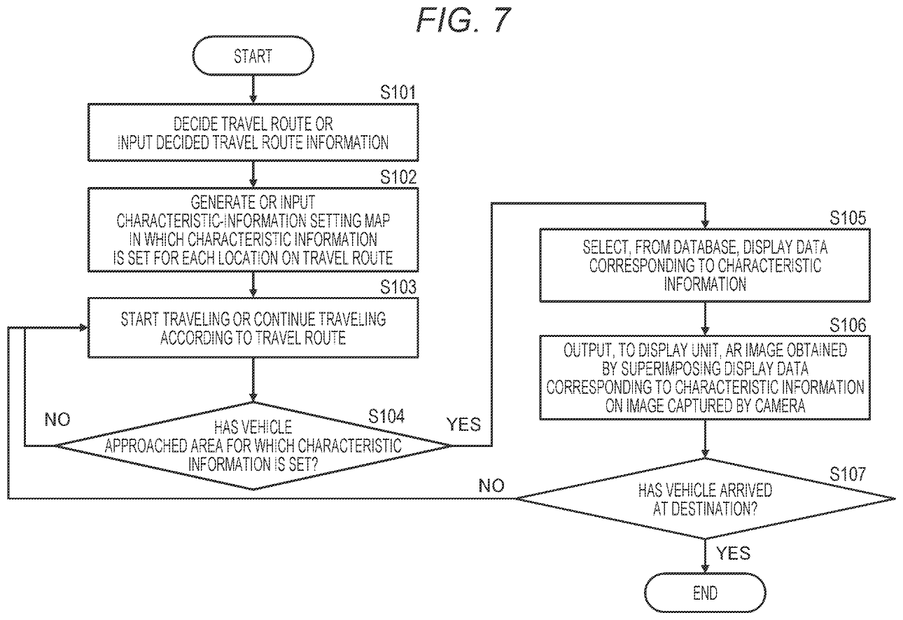

Next, a processing sequence of Example 1 will be described with reference to FIG. 7.

FIG. 7 is a flowchart describing a processing sequence in a case where processing executed by the information processing device according to the present disclosure, that is, processing according to (Example 1) described above is executed.

Note that the processing according to the flowcharts illustrated in FIG. 7 and subsequent drawings is executed in the data processing unit of the information processing device. The data processing unit includes a CPU having a program execution function, and can execute processing corresponding to a flow according to a program stored in the storage unit.

The processing of each step of the flow illustrated in FIG. 7 will be described.

(Step S101)

First, in step S101, the data processing unit of the information processing device decides a travel route of the vehicle or inputs decided travel route information.

For example, a travel route connecting (S) Departure point and (E) Destination point as described above with reference to FIG. 3 is decided.

As described above, (S) Departure point and (E) Destination point are set by the user or manager of the vehicle, and for example, a shortest travel route is decided on the basis of settings for (S) Departure point and (E) Destination point. Alternatively, the user or manager of the vehicle 10 may decide a travel route of the vehicle, and input the decided travel route information.

(Step S102)

Next, in step S102, the data processing unit of the information processing device generates or inputs a characteristic-information setting map in which characteristic information is set for each location on the travel route decided in step S101.

The characteristic-information setting map is a map described above with reference to FIG. 3, and is a map in which various pieces of characteristic information regarding a travel route from (S) Departure point to (E) Destination point of the vehicle are recorded.

In step S102, the data processing unit of the information processing device executes processing of generating a characteristic-information setting map as illustrated in FIG. 3 or processing of acquiring a characteristic-information setting map from outside.

In a case of generating a characteristic-information setting map, as described above, the information processing device utilizes, for example, the following information.

(1) Characteristic information acquired by traveling processing of camera-mounted vehicle executed in advance and stored in storage unit of information processing device or external server

(2) Real-time traffic information provided by external traffic-information provision server

(3) Real-time characteristic information (event information or the like) provided by external event-information provision server

Note that, for example, in a case where a latest characteristic-information setting map is stored in an external device such as an external server, the characteristic-information setting map may be acquired.

(Step S103)

Next, in step S103, the data processing unit of the information processing device starts traveling according to the travel route decided in step S101.

(Step S104)

Next, in step S104, the data processing unit of the information processing device determines whether or not the vehicle has approached an area for which characteristic information recorded on the characteristic-information setting map generated or acquired in step S102 is set. For example, it is determined whether or not the vehicle has approached within a predetermined distance (10 m or the like) of the area for which the characteristic information is set.

In a case where it is determined that the vehicle has approached an area for which characteristic information recorded on the characteristic-information setting map is set, the processing proceeds to step S105.

Meanwhile, in a case where it is determined that the vehicle has not approached an area for which characteristic information recorded on the characteristic-information setting map is set, the processing returns to step S103, and traveling processing according to the travel route is continued.

(Step S105)

In a case where it is determined in step S104 that the vehicle has approached an area for which characteristic information recorded on the characteristic-information setting map is set, the processing proceeds to step S105.

In step S105, the data processing unit of the information processing device selects, from the characteristic-information corresponding display data storage DB, display data corresponding to characteristic information that the vehicle is approaching.

As described above with reference to FIG. 6, in the characteristic-information corresponding display data storage DB, display data associated with various pieces of characteristic information are recorded.

In step S105, the data processing unit of the information processing device selects, from the characteristic-information corresponding display data storage DB, display data corresponding to characteristic information that the vehicle is approaching.

(Step S106)

Next, in step S106, the data processing unit of the information processing device generates an AR image obtained by superimposing display data acquired from the characteristic-information corresponding display data storage DB in step S105 on an image captured by the external camera, that is, a real object image obtained by capturing an image of external scenery, and then outputs the AR image to the display unit.

That is, the AR image is output to the display unit inside the vehicle described with reference to FIG. 2.

The display unit inside the vehicle displays an actual image of the external scenery captured by the camera outside the vehicle, and the information processing device generates and displays AR image display data obtained by superimposing a virtual object such as display data selected from the characteristic-information corresponding display data storage DB, that is image data of a whale for example, on the actual image including the real object.

Note that processing of displaying the display data acquired from the characteristic-information corresponding display data storage DB ends after the vehicle passes through the area for which the characteristic information is set. This end timing is performed according to a predetermined algorithm. For example, erasure processing is executed according to a predetermined algorithm to perform erasure 10 seconds after the vehicle passes the area for which the characteristic information is set, or to perform erasure after traveling 10 also from the area for which the characteristic information is set.

(Step S107)

Finally, in step S107, the information processing device determines whether or not the vehicle has arrived at the destination.

In a case where the vehicle has not arrived at the destination, the processing returns to step S103, the vehicle continues traveling along the travel route, and the processing in step S104 and subsequent steps is repeatedly executed.

In a case where the vehicle arrives at the destination, the processing ends.

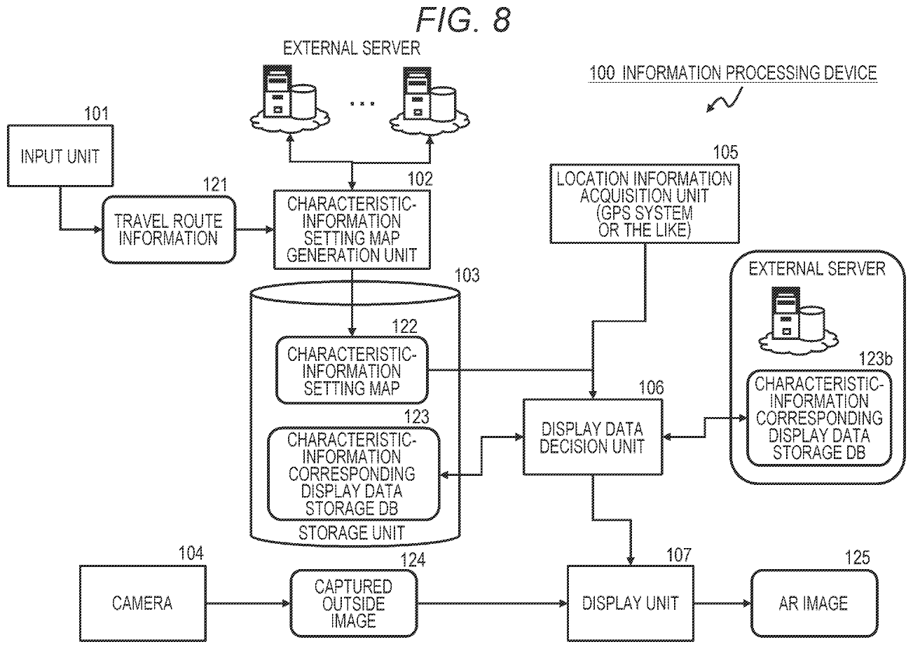

Next, a configuration example of an information processing device 100 that executes Example 1 will be described with reference to FIG. 8.

The information processing device 100 illustrated in FIG. 8 is mounted inside the vehicle 10 described with reference to FIGS. 1 and 2, for example. Alternatively, the information processing device 100 may be provided in an external device capable of communicating with the vehicle 10 via a communication unit.

As illustrated in FIG. 8, the information processing device 100 has an input unit 101, a characteristic-information setting map generation unit 102, a storage unit 103, a camera 104, a location information acquisition unit (GPS system or the like) 105, a display data decision unit 106, and a display unit 107.

The input unit 101 is, for example, an input unit with which the user performs processing of inputting a departure point and a destination point, inputting a travel route, or the like.

Travel route information 121 input via the input unit 101 is input to the characteristic-information setting map generation unit 102.

The characteristic-information setting map generation unit 102 generates a characteristic-information setting map in which various pieces of characteristic information are set at each location along the travel route of the input travel route information 121.

The characteristic-information setting map is a map described above with reference to FIG. 3, and is a map in which various pieces of characteristic information regarding a travel route from (S) Departure point to (E) Destination point of the vehicle are recorded.

In a case where a characteristic-information setting map is generated, the characteristic-information setting map generation unit 102 performs processing utilizing the following information, for example.

(1) Characteristic information acquired by traveling processing of camera-mounted vehicle executed in advance and stored in storage unit of information processing device or external server

(2) Real-time traffic information provided by external traffic-information provision server

(3) Real-time characteristic information (event information or the like) provided by external event-information provision server

A characteristic-information setting map 122 generated by the characteristic-information setting map generation unit 102 is stored in the storage unit 103. Note that the characteristic-information setting map 122 may be stored in the external server.

The camera 104 is a camera that captures an image of outside of the vehicle 10, that is, scenery. A captured outside image 124 captured by the camera 104 is displayed on the display unit 107.

The display unit 107 is a display unit inside the vehicle, that is, a display unit such as the front display unit 21, the left-side surface display unit 22, or the right-side surface display unit 23 provided inside the vehicle described above with reference to FIG. 2.

The location information acquisition unit (GPS system or the like) 105 executes communication with, for example, a GPS satellite or the like to analyze a current location of the vehicle.

The analyzed location information is input to the display data decision unit 106.

The display data decision unit 106 inputs current location information of the vehicle from the location information acquisition unit (GPS system or the like) 105.

By utilizing the location information, the display data decision unit 106 determines whether or not the vehicle has approached the area for which the characteristic information recorded on the characteristic-information setting map 122 acquired from the storage unit 103 is set. For example, it is determined whether or not the vehicle has approached within a predetermined distance (10 m or the like) of the area for which the characteristic information is set.

In a case where the vehicle has approached the area for which characteristic information recorded on the characteristic-information setting map 122 is set, the display data decision unit 106 selects, from a characteristic-information corresponding display data storage DB 123 stored in the storage unit 103, display data corresponding to the characteristic information that the vehicle is approaching.

Note that the display data decision unit 106 may utilize a characteristic-information corresponding display data storage DB 123b held by the external server as illustrated in FIG. 8.

As described above with reference to FIG. 6, in the characteristic-information corresponding display data storage DB, display data associated with various pieces of characteristic information are recorded.

From the characteristic-information corresponding display data storage DB 123, the display data decision unit 106 selects display data corresponding to the characteristic information that the vehicle is approaching.

On the display unit 107 displaying an image captured by the external camera, that is, a captured outside image obtained by capturing an image of external scenery, the display data decision unit 106 superimposes display data acquired from the characteristic-information corresponding display data storage DB 123, and displays the display data.

As a result, an AR image 125 obtained by superimposing the display data (virtual object image) acquired from the characteristic-information corresponding display data storage DB 123 on the captured outside image (real object image) obtained by capturing the image of the external scenery is displayed on the display unit 107 inside the vehicle.

[2-2. (Example 2) Example of performing, during travel on travel route from departure place to destination, display information control in which characteristic scene is extracted from image captured by camera that captures image of outside of vehicle, and image corresponding to extracted characteristic scene is output]

Next, (Example 2) Example of performing, during travel on travel route from departure place to destination, display information control in which characteristic scene is extracted from image captured by camera that captures image of outside of vehicle, and image corresponding to extracted characteristic scene is output will be described.

Example 2 is Example in which, while the vehicle is traveling, an image captured by a camera that captures an image of outside of the vehicle is analyzed, and display data (content) to be output to the display unit is decided on the basis of a result of the analysis.

In Example 2, for example, optimum display data (content) corresponding to a current situation is sequentially decided and displayed on the basis of a result of analyzing in real time an outside image captured while the vehicle is traveling. This is Example in which optimum content corresponding to a situation is displayed in a so-called ad-lib manner.

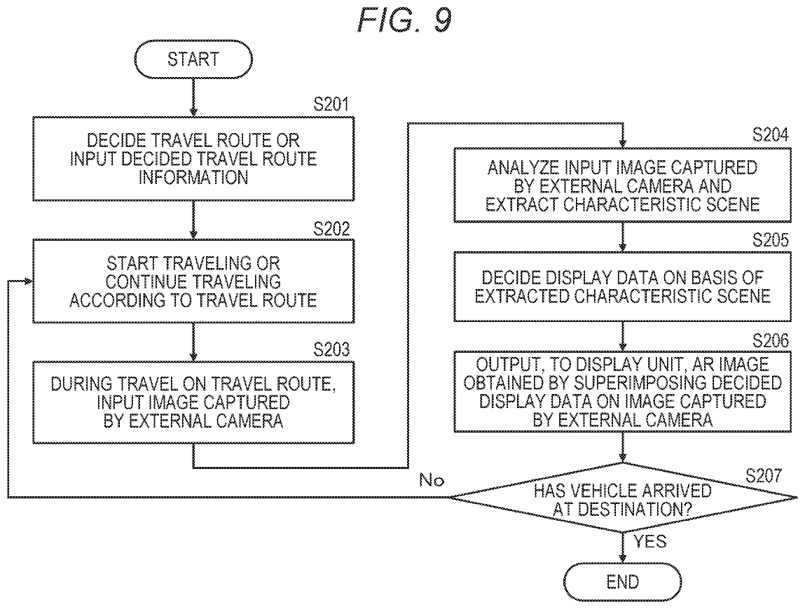

A processing sequence of Example 2 will be described with reference to FIG. 9.

The processing of each step of the flow illustrated in FIG. 9 will be described.

(Step S201)

First, in step S201, the data processing unit of the information processing device decides a travel route of the vehicle or inputs decided travel route information.

For example, a travel route connecting (S) Departure point and (E) Destination point as described above with reference to FIG. 3 is decided.

As described above, (S) Departure point and (E) Destination point are set by the user or manager of the vehicle, and for example, a shortest travel route is decided on the basis of settings for (S) Departure point and (E) Destination point. Alternatively, the user or manager of the vehicle 10 may decide a travel route of the vehicle, and input the decided travel route information.

(Step S202)

Next, in step S202, the data processing unit of the information processing device starts traveling according to the travel route decided in step S201.

(Step S203)

Next, in step S203, the data processing unit of the information processing device inputs the image captured by the external camera that captures an image of outside of vehicle.

For example, an image captured by the camera 12 mounted outside the vehicle 10 illustrated in FIG. 1 is input.

(Step S204)

Next, in step S204, the data processing unit of the information processing device analyzes the image captured by the camera and extracts a characteristic scene, the image being input in step S203.

The characteristic scene is, for example, an image scene corresponding to the characteristic information described in Example 1 described above, and is a scene indicating a characteristic of current scenery or the like that can be analyzed from the image captured by the camera. Specifically,

(1) Building street

(2) Park under open sky

(3) In traffic congestion

(4) PQ Store location

Data indicating a characteristic of scenery that can be analyzed from an image as in (1) to (4) described above is extracted as a characteristic scene.

(Step S205)

Next, in step S205, the data processing unit of the information processing device decides display data on the basis of the characteristic scene extracted in step S204.

Specifically, the display data is decided on the basis of the characteristic scene extracted in step S204 by utilizing a characteristic-scene corresponding display data storage database in which the characteristic scene and the display data are associated with each other.

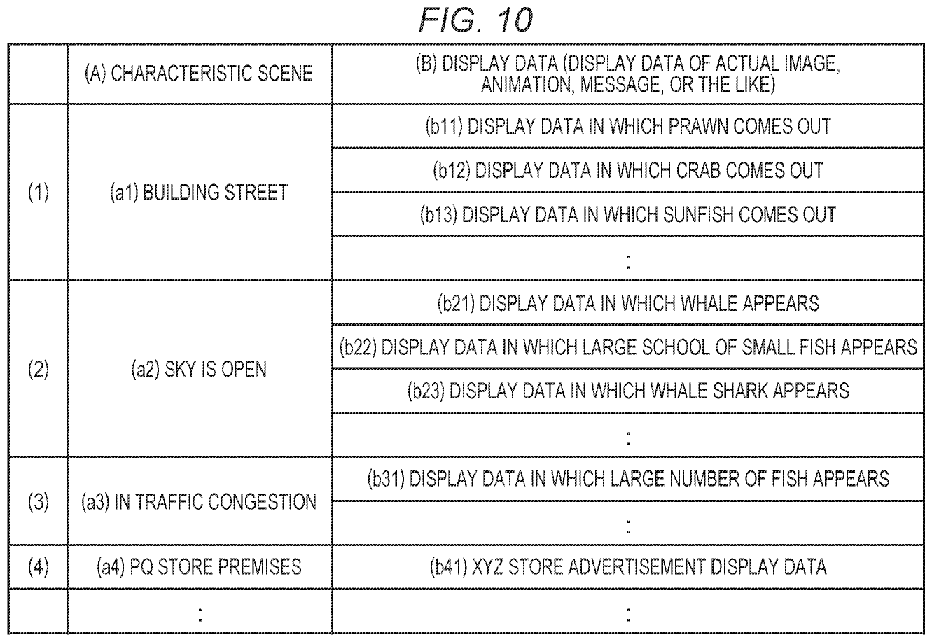

FIG. 10 illustrates a specific example of the characteristic-scene corresponding display data storage database.

As illustrated in FIG. 10, the characteristic-scene corresponding display data storage database is a database in which data of correspondence between each characteristic scene and display data is recorded. The characteristic-scene corresponding display data storage database corresponds to a database in which [(A) Characteristic information] in the characteristic-information corresponding display data storage DB described above with reference to FIG. 6 is replaced with [(A) Characteristic scene].

Specifically, as illustrated in FIG. 10, data as below is associated and recorded.

(A) Characteristic scene=(a1) Building street

(B) Display data

(b11) Display data in which prawn comes out

(b12) Display data in which crab comes out

(b13) Display data in which sunfish comes out

(A) Characteristic scene=(a2) Sky is open

(B) Display data

(b21) Display data in which whale appears

(b22) Display data in which large school of small fish appears

(b23) Display data in which whale shark appears

(A) Characteristic scene=(a3) In traffic congestion

(B) Display data

(b31) Display data in which large number of fish appears

(A) Characteristic scene=(a4) PQ store premises (B) Display data

(b41) XYZ store advertisement display data

The storage unit of the information processing device includes, for example, a characteristic-scene corresponding display data storage DB that stores corresponding data as illustrated in FIG. 10.

Note that data stored as (B) Display data in the characteristic-scene corresponding display data storage DB is image data or animation data, that is, for example, video data of a captured image of a whale, animation image data, or image data for displaying a message image or the like.

The information processing device holds, in the storage unit, the characteristic-scene corresponding display data storage DB in which a characteristic scene and display data are associated with each other. The data processing unit (display control unit) of the information processing device refers to the database, and selects and displays display data corresponding to a characteristic scene.

Note that actual image data or animation data may not be stored in the characteristic-scene corresponding display data storage DB held by the information processing device, and access information (URL or the like) for acquiring actual image data or animation data from an external device may be recorded.

In this case, the information processing device performs processing of acquiring the actual image data or animation data from the external device by utilizing the access information (URL or the like).

Note that an entire characteristic-scene corresponding display data storage DB may be held by an external device such as an external server for example, and the information processing device of the vehicle may access the external server to perform processing of acquiring the display data associated with the characteristic scene.

(Step S206)

Next, in step S206, the data processing unit of the information processing device generates an AR image obtained by superimposing display data acquired from the characteristic-scene corresponding display data storage DB in step S205 on an image captured by the external camera, that is, a real object image obtained by capturing an image of external scenery, and then outputs the AR image to the display unit.

That is, the AR image is output to the display unit inside the vehicle described with reference to FIG. 2.

The display unit inside the vehicle displays an actual image of the external scenery captured by the camera outside the vehicle, and the information processing device generates and displays AR image display data obtained by superimposing a virtual object such as display data selected from the characteristic-scene corresponding display data storage DB, that is image data of a whale for example, on the actual image including the real object.

Note that, similarly to Example 1 described above, processing of displaying the display data acquired from the characteristic-scene corresponding display data storage DB ends after the vehicle passes through the area in which an image of the characteristic scene is captured. This end timing is performed according to a predetermined algorithm. For example, erasure processing is executed according to a predetermined algorithm to perform erasure 10 seconds after the vehicle passes the area in which the image of the characteristic scene is captured, or to perform erasure after traveling 10 also from the area in which the image of the characteristic scene is captured.

(Step S207)

Finally, in step S207, the information processing device determines whether or not the vehicle has arrived at the destination.

In a case where the vehicle has not arrived at the destination, the processing returns to step S202, the vehicle continues traveling along the travel route, and the processing in step S203 and subsequent steps is repeatedly executed.

In a case where the vehicle arrives at the destination, the processing ends.

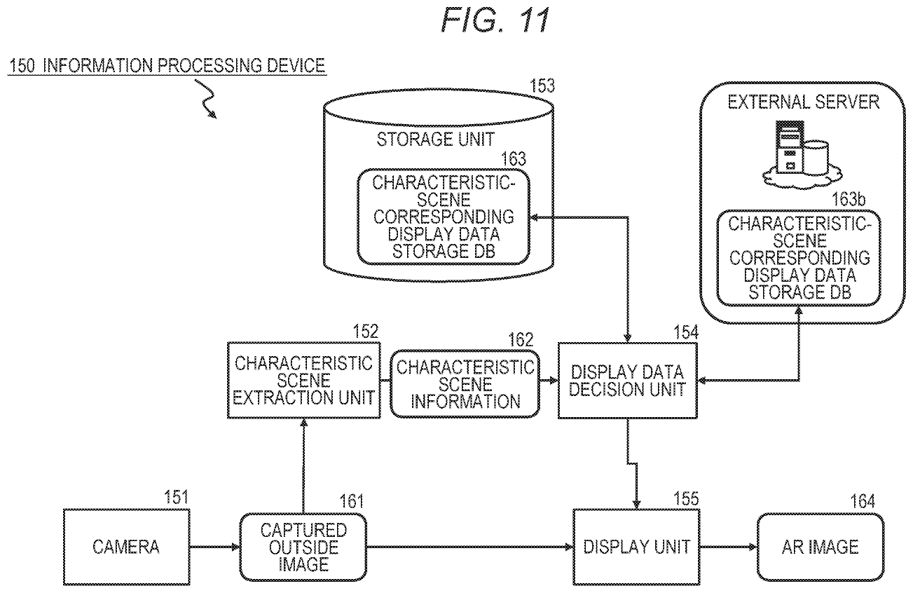

Next, a configuration example of an information processing device 150 that executes Example 2 will be described with reference to FIG. 11.

The information processing device 150 illustrated in FIG. 11 is mounted inside the vehicle 10 described with reference to FIGS. 1 and 2, for example. Alternatively, the information processing device 100 may be provided in an external device capable of communicating with the vehicle 10 via a communication unit.

As illustrated in FIG. 11, the information processing device 150 has a camera 151, a characteristic scene extraction unit 152, a storage unit 153, a display data decision unit 154, and a display unit 155.

The camera 151 is a camera that captures an image of outside of the vehicle 10, that is, scenery. A captured outside image 161 captured by the camera 151 is displayed on the display unit 155.

The display unit 155 is a display unit inside the vehicle, that is, a display unit such as the front display unit 21, the left-side surface display unit 22, or the right-side surface display unit 23 provided inside the vehicle described above with reference to FIG. 2.

In Example 2, the captured outside image 161 captured by the camera 151 is further input to the characteristic scene extraction unit 152.

The characteristic scene extraction unit 152 analyzes the captured outside image 161 captured by the camera 151 and extracts a characteristic scene. The characteristic scene is a scene indicating a characteristic of current scenery that can be analyzed from the image captured by the camera. Specifically,

(1) Building street

(2) Park under open sky

(3) In traffic congestion

(4) PQ Store location

Data indicating a characteristic of scenery that can be analyzed from an image as in (1) to (4) described above is extracted as a characteristic scene.

Note that, as one specific processing example of characteristic scene extraction processing, it is possible to apply a method for analyzing a difference between a newly input image of current scenery captured by a camera and average data of images captured in the past. The processing example will be described later.

Characteristic scene information 162 extracted by the characteristic scene extraction unit 152 from the image captured by the camera, that is, for example, characteristic scene information 162 of Building street, Park under open sky, In traffic congestion, PQ Store location, or the like is input to the display data decision unit 154.

The display data decision unit 154 searches, on the basis of the characteristic scene information 162 input from the characteristic scene extraction unit 152, a characteristic-scene corresponding display data storage DB 163 stored in the storage unit 153, and selects display data recorded in the database in association with the characteristic scene information 162.

Note that the display data decision unit 106 may utilize a characteristic-scene corresponding display data storage DB 163b held by an external server as illustrated in FIG. 11.

As described above with reference to FIG. 10, in the characteristic-scene corresponding display data storage DB, display data associated with various kinds of characteristic scene information are recorded.

The display data decision unit 154 selects, from the characteristic-scene corresponding display data storage DB 163, display data corresponding to a characteristic scene analyzed from an image captured by the camera.

On the display unit 155 displaying an image captured by the external camera, that is, a captured outside image obtained by capturing an image of external scenery, the display data decision unit 154 superimposes display data acquired from the characteristic-scene corresponding display data storage DB 163, and displays the display data.

As a result, an AR image 164 obtained by superimposing the display data (virtual object image) acquired from the characteristic-scene corresponding display data storage DB 163 on the captured outside image (real object image) obtained by capturing the image of the external scenery is displayed on the display unit 155 inside the vehicle.

As described above, the characteristic scene extraction unit 152 analyzes the captured outside image 161 captured by the camera 151 and extracts a characteristic scene. The characteristic scene is a scene indicating a characteristic of current scenery that can be analyzed from an image captured by a camera, and data indicating a characteristic of scenery, such as (1) Building street, (2) Park under open sky, (3) In traffic congestion, or (4) a PQ Store location, that can be analyzed from the image is extracted as the characteristic scene.

As one specific processing example of characteristic scene extraction processing, it is possible to apply a method for analyzing a difference between an image of current scenery captured by the camera and average data of images captured in the past. An example of the processing will be described.

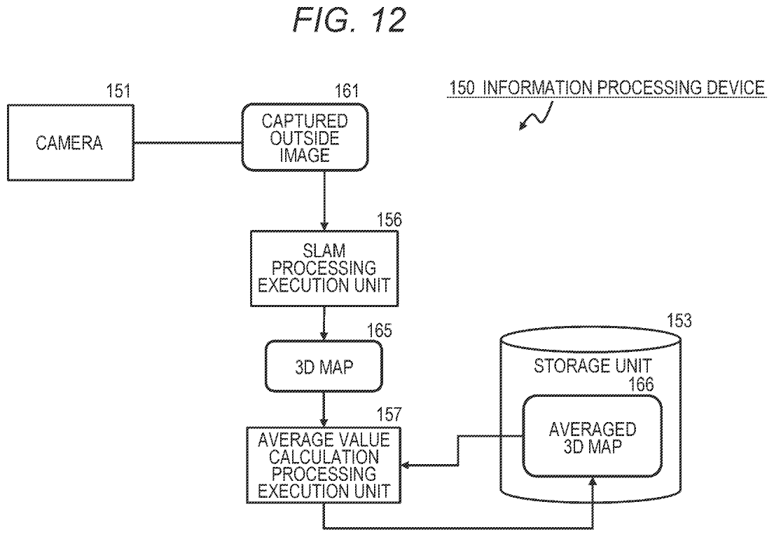

FIG. 12 is a diagram illustrating a configuration of processing of generating an “averaged 3D map 166” that is average data of images captured in the past and applied to characteristic scene extraction processing.

By applying the configuration illustrated in FIG. 12, the information processing device 150 described with reference to FIG. 11 generates, in advance, the averaged 3D map 166 to be applied to the characteristic scene extraction processing, and stores the averaged 3D map 166 in the storage unit 153.

The processing of generating the averaged 3D map 166 to which the configuration illustrated in FIG. 12 is applied is pre-processing performed before executing the AR image display processing described with reference to FIG. 11. The pre-processing will be described with reference to FIG. 12.

While the vehicle 10 is traveling, the captured outside image 161 captured by the camera 151 is input to a SLAM processing execution unit 156.

The SLAM processing execution unit 156 executes SLAM processing, that is, simultaneous localization and mapping (SLAM) processing for executing camera location identification (localization) and environmental map creation (mapping) in parallel.

A 3D map 165 generated by the SLAM processing is input to an average value calculation processing execution unit 157.

The 3D map 165 is a 3D map of vehicle periphery of which image is captured by a camera of the vehicle, and is a 3D map capable of analyzing images observed from various kinds of vehicle locations.

The average value calculation processing execution unit 157 acquires, from the storage unit 153, the averaged 3D map 166 that is already generated, executes processing of averaging the acquired averaged 3D map 166 and a latest 3D map 165 generated in SLAM processing newly executed by the SLAM processing execution unit 156, updates the averaged 3D map 166, and stores the averaged 3D map 166 in the storage unit 153.

This processing is repeatedly executed when the vehicle travels on the same traveling path. Thus, by the 3D-map averaging processing repeatedly executed, the averaged 3D map 166 stored in the storage unit 153 is sequentially updated.

The characteristic scene extraction unit 152 of the information processing device 150 illustrated in FIG. 11 can refer to the averaged 3D map 166 stored in the storage unit 153, analyze a difference from the captured outside image 161 newly captured by the camera 151, and extract the difference as a characteristic scene.

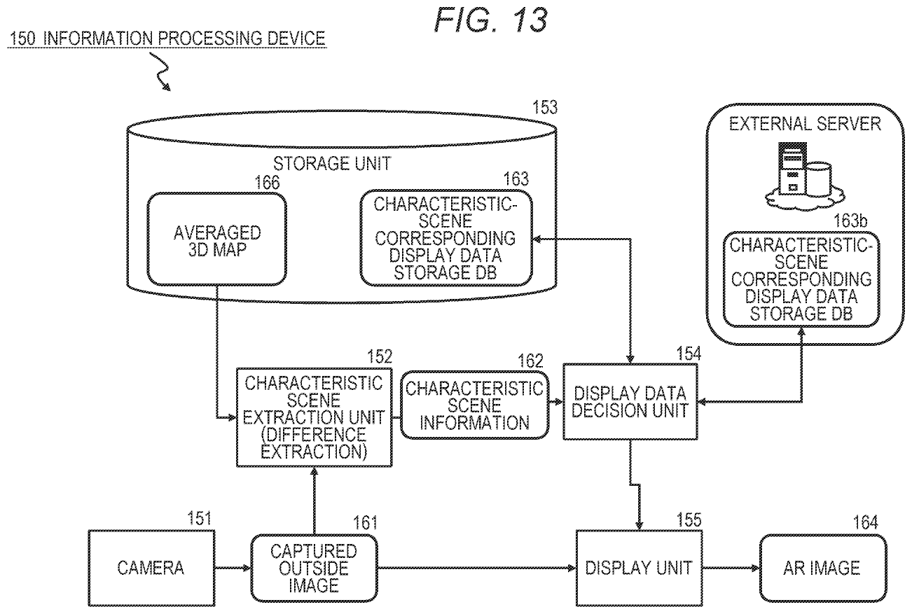

FIG. 13 illustrates a configuration example of the information processing device 150 that performs characteristic scene extraction processing by utilizing the averaged 3D map 166 stored in the storage unit 153.

The information processing device 150 illustrated in FIG. 13 has basically the same configuration as the information processing device 150 described above with reference to FIG. 11.

It is indicated that the information processing device 150 illustrated in FIG. 13 is configured such that the characteristic scene extraction unit 152 extracts a characteristic scene by utilizing the averaged 3D map 166 stored in the storage unit 153.

The characteristic scene extraction unit 152 of the information processing device 150 illustrated in FIG. 13 refers to the averaged 3D map 166 stored in the storage unit 153 according to the processing described with reference to FIG. 12, and executes characteristic scene extraction processing.

The characteristic scene extraction unit 152 compares the captured outside image 161 newly captured by the camera 151 with the averaged 3D map 166 stored in the storage unit 153, analyzes a difference therebetween, and extracts the difference as a characteristic scene.

Specifically, for example, it is assumed that an image of “Cherry-blossom viewing” in a park is captured in the captured outside image 161 captured by the camera 151 while the vehicle 10 is traveling in April.

Meanwhile, an image of the park in the averaged 3D map 166 stored in the storage unit 153 is an image of the park having a quiet atmosphere where no “Cherry-blossom viewing” is held.

In this case, the characteristic scene extraction unit 152 extracts this difference as a characteristic scene. That is, “Park where cherry-blossom viewing is being held” is extracted as a characteristic scene information, and the characteristic scene information is output to the display data decision unit 154.

The display data decision unit 154 can search, on the basis of the characteristic scene information 162 input from the characteristic scene extraction unit 152, which is

Characteristic scene information=“Park where cherry-blossom viewing is being held”,

the characteristic-scene corresponding display data storage DB 163 stored in the storage unit 153, and can select display data recorded in the database in association with the characteristic scene information 162.

With this processing, it is possible to select and display optimum content based on a characteristic of scenery or the like obtained in real time.

That is, it is possible to perform processing of displaying content corresponding to a current situation in an ad-lib manner.

[2-3. (Example 3) Example of performing, during travel on travel route from departure place to destination, display information control in which display data is decided on basis of detection information from various kinds of sensors, such as camera, and other acquired information, and decided display data is output]

Next, (Example 3) Example of performing, during travel on travel route from departure place to destination, display information control in which display data is decided on basis of detection information from various kinds of sensors, such as camera, and other acquired information, and decided display data is output will be described.

In Example 2 described above, the characteristic scene is extracted by utilizing an image captured by the external camera. Meanwhile, Example 3 described below is Example of performing display information control in which characteristic information is detected on the basis not only of an image captured by an external camera but also of information detected by various kinds of sensors or information acquired from an external server or the like, display data is decided on the basis of the detected characteristic information, and the decided display data is output.

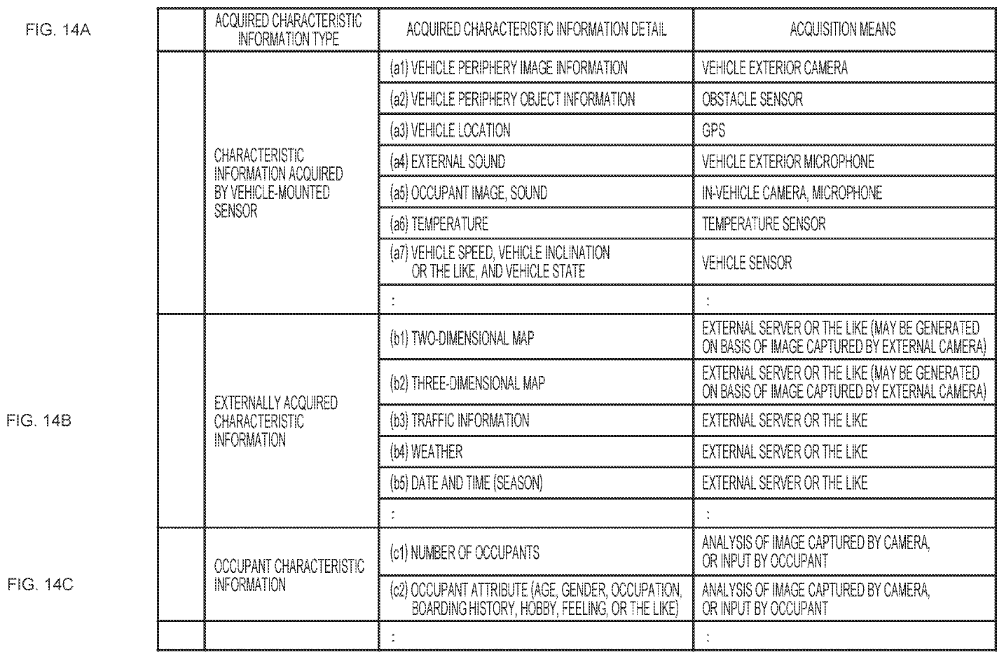

An example of characteristic information utilized for processing of deciding display data in Example 3 will be described with reference to FIG. 14.

As illustrated in FIG. 14, in Example 3, characteristic information utilized for processing of deciding display data includes, for example, information of the following different categories.

FIG. 14 illustrates characteristic information of the following three categories.

(a) Characteristic information acquired by vehicle-mounted sensor

(b) Externally acquired characteristic information

(c) Occupant characteristic information

(a) Characteristic information acquired by vehicle-mounted sensor is, for example, characteristic information acquired by a sensor mounted on the vehicle 10, such as a camera, a microphone, or a speed sensor, and includes, for example, the following information.

(a1) Vehicle periphery image information

(a2) Vehicle periphery object information

(a3) Vehicle location

(a4) External sound

(a5) Occupant image

(a6) Occupant sound

(a7) Vehicle speed, vehicle inclination, and vehicle state

(b) Externally acquired characteristic information is, for example, characteristic information acquired from an external information provision server or the like, and includes, for example, the following information.

(b1) Two-dimensional map

(b2) Three-dimensional map

(b3) Traffic information

(b4) Weather

(b5) Date and time (season)

(c) Occupant characteristic information is characteristic information of an occupant in the vehicle 10. (c) Occupant characteristic information is characteristic information, which is acquired by analysis information of an image of an occupant captured by a camera, information input by the occupant, or the like, and includes, for example, the following information.

(c1) Number of occupants

(c2) Occupant attribute (age, gender, occupation, boarding history, hobby, feeling, or the like)

In Example 3, for example, display data is decided on the basis of the characteristic information acquired by acquiring these pieces of characteristic information.

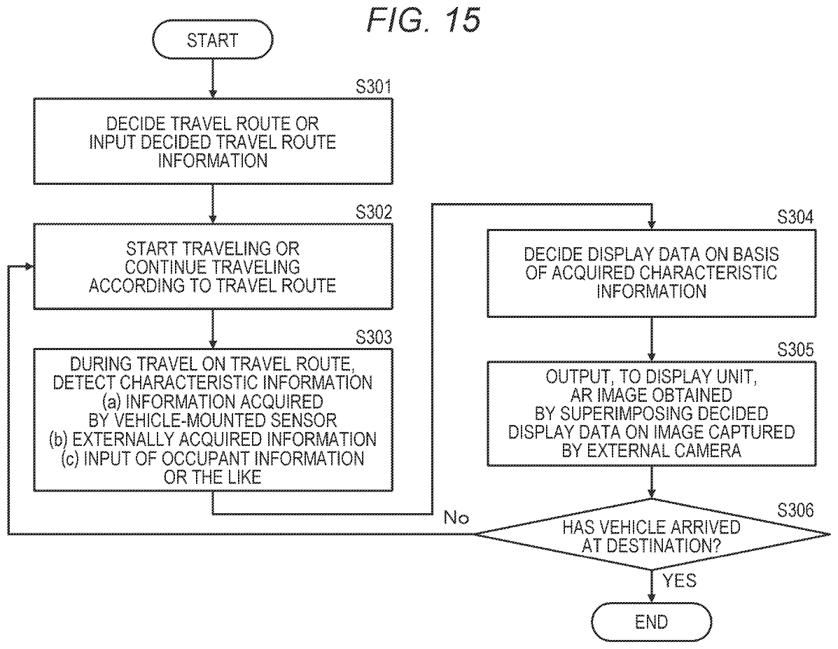

A processing sequence of Example 3 will be described with reference to FIG. 15.

The processing of each step of the flow illustrated in FIG. 15 will be described.

(Step S301)

First, in step S301, the data processing unit of the information processing device decides a travel route of the vehicle or inputs decided travel route information.

For example, a travel route connecting (S) Departure point and (E) Destination point as described above with reference to FIG. 3 is decided.

As described above, (S) Departure point and (E) Destination point are set by the user or manager of the vehicle, and for example, a shortest travel route is decided on the basis of settings for (S) Departure point and (E) Destination point. Alternatively, the user or manager of the vehicle 10 may decide a travel route of the vehicle, and input the decided travel route information.

(Step S302)

Next, in step S302, the data processing unit of the information processing device starts traveling according to the travel route decided in step S301.

(Step S303)

Next, in step S303, the data processing unit of the information processing device acquires various pieces of characteristic information while the vehicle is traveling. That is, the following various pieces of characteristic information described above with reference to FIG. 14 are acquired.

(a) Characteristic information acquired by vehicle-mounted sensor

(b) Externally acquired characteristic information

(c) Occupant characteristic information

These pieces of information are acquired from various kinds of information sources such as a sensor such as a camera mounted on the vehicle, an external server, or information input by an occupant.

(Step S304)

Next, in step S304, the data processing unit of the information processing device decides display data on the basis of the characteristic information acquired in step S303.

By utilizing the characteristic-information corresponding display data storage database in which various pieces of characteristic information and display data are associated with each other, the data processing unit of the information processing device decides display data on the basis of the characteristic information acquired in step S303.

The information processing device holds, in the storage unit, the characteristic-information corresponding display data storage DB in which various pieces of characteristic information and display data are associated with each other. The data processing unit (display control unit) of the information processing device refers to the database, and selects and displays display data corresponding to the detected characteristic information.

Note that the characteristic-information corresponding display data storage DB in which various pieces of characteristic information and display data are associated with each other records, for example, data of correspondence between characteristic information and display data as below, in addition to the database configuration data described above with reference to FIG. 6.

(1) Example of data of correspondence between characteristic information and display data 1

(1a) Characteristic information=Laughter of occupant (sound picked up by in-vehicle microphone)

(1b) Display data=Image of flower field

(2) Example of data of correspondence between characteristic information and display data 2

(2a) Characteristic information=Snow (Information acquired from external weather-information provision server)

(2b) Display data=Snowman

For example, the data processing unit (display control unit) of the information processing device refers to a database in which these corresponding data are record, and selects and displays display data corresponding to the detected characteristic information.

Note that actual image data or animation data may not be stored in the characteristic-information corresponding display data storage DB held by the information processing device, and access information (URL or the like) for acquiring actual image data or animation data from an external device may be recorded.

In this case, the information processing device performs processing of acquiring the actual image data or animation data from the external device by utilizing the access information (URL or the like).

Note that an entire characteristic-information corresponding display data storage DB may be held by an external device such as an external server for example, and the information processing device of the vehicle may access the external server to perform processing of acquiring the display data associated with the characteristic information.

(Step S305)

Next, in step S305, the data processing unit of the information processing device generates an AR image obtained by superimposing display data acquired from the characteristic-information corresponding display data storage DB in step S304 on an image captured by the external camera, that is, a real object image obtained by capturing an image of external scenery, and then outputs the AR image to the display unit.

That is, the AR image is output to the display unit inside the vehicle described with reference to FIG. 2.

The display unit inside the vehicle displays an actual image of the external scenery captured by the camera outside the vehicle, and the information processing device generates and displays AR image display data obtained by superimposing a virtual object such as display data selected from the characteristic-information corresponding display data storage DB, that is image data of a snowman for example, on the actual image including the real object.

Note that processing of displaying the display data acquired from the characteristic-information corresponding display data storage DB ends after the vehicle passes through the area for which the characteristic information is set. This end timing is performed according to a predetermined algorithm. For example, erasure processing is executed according to a predetermined algorithm to perform erasure 10 seconds after the vehicle passes the area for which the characteristic information is set, or to perform erasure after traveling 10 also from the area for which the characteristic information is set.

(Step S306)

Finally, in step S306, the information processing device determines whether or not the vehicle has arrived at the destination.

In a case where the vehicle has not arrived at the destination, the processing returns to step S302, the vehicle continues traveling along the travel route, and the processing in step S303 and subsequent steps is repeatedly executed.

In a case where the vehicle arrives at the destination, the processing ends.

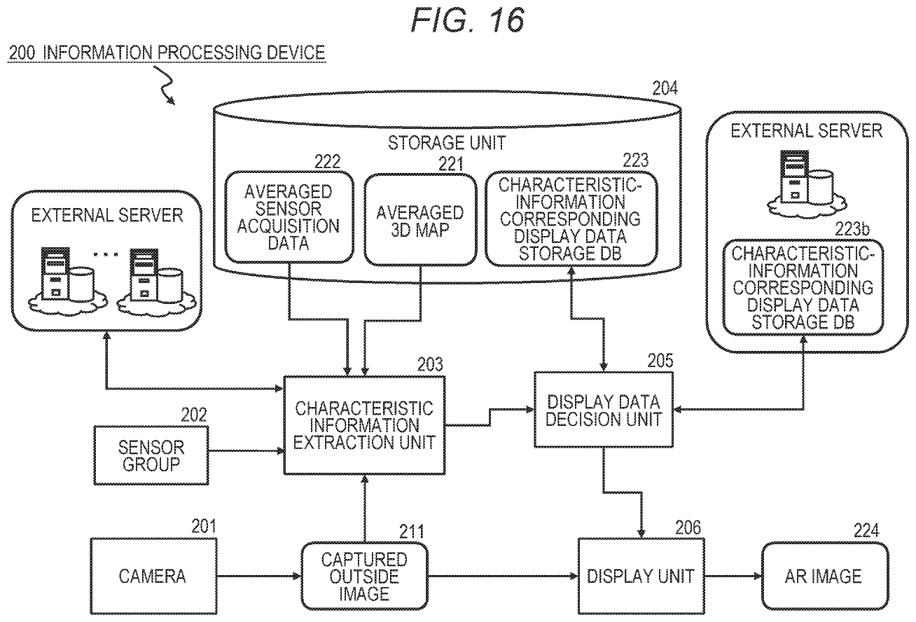

Next, a configuration example of an information processing device 200 that executes Example 3 will be described with reference to FIG. 16.

The information processing device 200 illustrated in FIG. 16 is mounted inside the vehicle 10 described with reference to FIGS. 1 and 2, for example. Alternatively, the information processing device 100 may be provided in an external device capable of communicating with the vehicle 10 via a communication unit.

As illustrated in FIG. 16, the information processing device 200 has a camera 201, a sensor group 202, a characteristic information extraction unit 203, a storage unit 204, a display data decision unit 205, and a display unit 206.

The camera 201 is a camera that captures an image of outside of the vehicle 10, that is, scenery. A captured outside image 211 captured by the camera 201 is displayed on the display unit 206.

The display unit 206 is a display unit inside the vehicle, that is, a display unit such as the front display unit 21, the left-side surface display unit 22, or the right-side surface display unit 23 provided inside the vehicle described above with reference to FIG. 2.

In Example 3, the captured outside image 211 captured by the camera 201 is further input to the characteristic information extraction unit 203.

The characteristic information extraction unit 203 further inputs various pieces of sensor detection information from the sensor group 202, and further inputs various pieces of information from the external server.

The sensor group includes various kinds of sensors such as a camera, a microphone, a temperature sensor, an inclination sensor, and a speed sensor.

Furthermore, the external server includes various kinds of external servers such as a traffic-information provision server, an event-information provision server, and a weather-information provision server.

Information input from a camera, a sensor, the external server, or the like to the characteristic information extraction unit 203 corresponds to the characteristic information described above with reference to FIG. 14. That is, the following various pieces of characteristic information described above with reference to FIG. 14 are input to the characteristic information extraction unit 203.

(a) Characteristic information acquired by vehicle-mounted sensor

(b) Externally acquired characteristic information

(c) Occupant characteristic information

The characteristic information extraction unit 203 analyzes the characteristic information on the basis of these pieces of input information and extracts characteristic information different from characteristic information in a normal time.

Note that, as one specific processing example of the characteristic information extraction processing, it is possible to apply a method for analyzing a difference between a newly input image of current scenery captured by the camera and average data of images captured in the past. That is, it is possible to apply processing of extracting a difference between an averaged 3D map generated according to the processing described with reference to FIG. 12 in Example 2 above and the captured outside image 211 currently being captured.

Moreover, in Example 3, processing of extracting characteristic information is executed on the basis of not only of an image captured by a camera but also of sound picked up by the microphone, or inclination information or the like of vehicle utilization by a vehicle sensor.

In this case also, similarly to a case of an averaged 3D map, processing of comparing averaged sensor acquisition data with current sensor acquisition information is executed, and processing of extracting a difference, or the like is executed.

As illustrated in FIG. 16, the storage unit 204 stores an averaged 3D map 221 and averaged sensor acquisition data 222.

The characteristic information value extraction unit 203 executes processing of comparing averaged data stored in the storage unit with a current image captured by a camera or sensor acquisition information to extract a difference, and outputs the extracted difference to the display data decision unit 205 as characteristic information.

The display data decision unit 205 searches, on the basis of the characteristic information input from the characteristic information extraction unit 203, a characteristic-information corresponding display data storage DB 223 stored in the storage unit 204, and selects display data recorded in the database in association with the characteristic information.

Note that the display data decision unit 205 may utilize a characteristic-information corresponding display data storage DB 223b held by the external server as illustrated in FIG. 16.

[2-4. (Example 4) Example of performing display information control in which image corresponding to characteristic information set in characteristic-information setting map is output by utilizing characteristic-information setting map corresponding to travel route from departure place to destination, and performing travel control of vehicle according to characteristic information set in characteristic-information setting map]

Next, (Example 4) Example of performing display information control in which image corresponding to characteristic information set in characteristic-information setting map is output by utilizing characteristic-information setting map corresponding to travel route from departure place to destination, and performing travel control of vehicle according to characteristic information set in characteristic-information setting map will be described.

In Example 4, similarly to Example 1 described above, there is performed display information control for outputting an image corresponding to characteristic information set in the characteristic-information setting map. Moreover, in Example 4, travel control of the vehicle is performed according to the characteristic information set in the characteristic-information setting map.

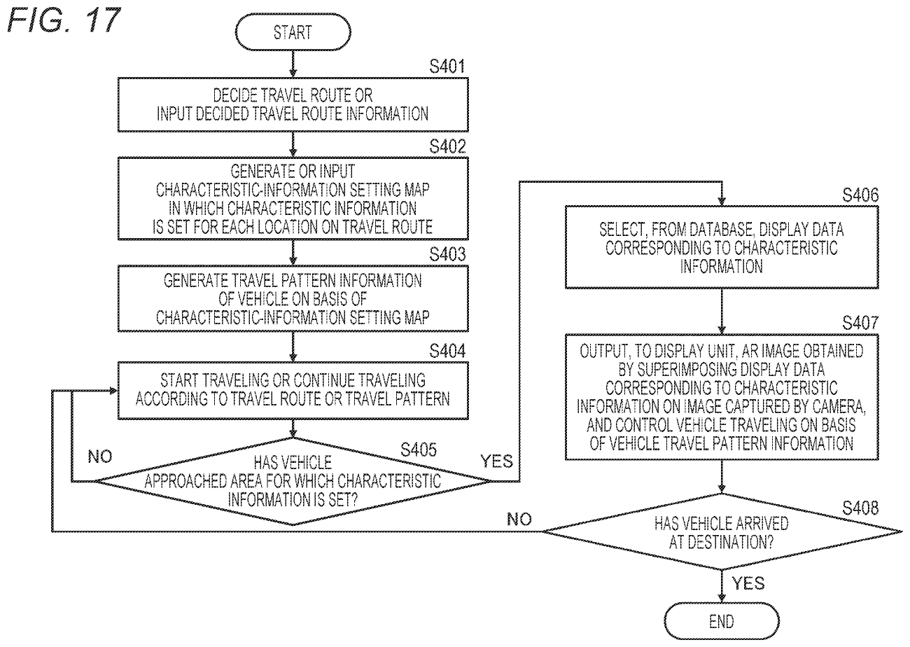

A processing sequence of Example 4 will be described with reference to FIG. 17.

The processing of each step of the flow illustrated in FIG. 17 will be described.

(Step S401)

First, in step S401, the data processing unit of the information processing device decides a travel route of the vehicle or inputs decided travel route information.

For example, a travel route connecting (S) Departure point and (E) Destination point as described above with reference to FIG. 3 is decided.

As described above, (S) Departure point and (E) Destination point are set by the user or manager of the vehicle, and for example, a shortest travel route is decided on the basis of settings for (S) Departure point and (E) Destination point. Alternatively, the user or manager of the vehicle 10 may decide a travel route of the vehicle, and input the decided travel route information.

(Step S402)

Next, in step S402, the data processing unit of the information processing device generates or inputs a characteristic-information setting map in which characteristic information is set for each location on the travel route decided in step S401.

The characteristic-information setting map is a map described above with reference to FIG. 3, and is a map in which various pieces of characteristic information regarding a travel route from (S) Departure point to (E) Destination point of the vehicle are recorded.

In step S402, the data processing unit of the information processing device executes processing of generating a characteristic-information setting map as illustrated in FIG. 3 or processing of acquiring a characteristic-information setting map from outside.

In a case of generating a characteristic-information setting map, as described above, the information processing device utilizes, for example, the following information.

(1) Characteristic information acquired by traveling processing of camera-mounted vehicle executed in advance and stored in storage unit of information processing device or external server

(2) Real-time traffic information provided by external traffic-information provision server

(3) Real-time characteristic information (event information or the like) provided by external event-information provision server

Note that, for example, in a case where a latest characteristic-information setting map is stored in an external device such as an external server, the characteristic-information setting map may be acquired.

(Step S403)

Next, in step S403, the data processing unit of the information processing device decides travel pattern information of the vehicle on the basis of the characteristic-information setting map generated or input in step S402.

For example, there is generated travel pattern information of reducing travel speed in a section in which characteristic information is set and display data corresponding to the characteristic information is displayed.

The generated travel pattern information is stored in the storage unit.

(Step S404)

Next, in step S404, the data processing unit of the information processing device starts traveling according to the travel route decided in step S401 and the travel pattern decided in step S403.

(Step S405)

Next, in step S405, the data processing unit of the information processing device determines whether or not the vehicle has approached an area for which characteristic information recorded on the characteristic-information setting map generated or acquired in step S402 is set. For example, it is determined whether or not the vehicle has approached within a predetermined distance (10 m or the like) of the area for which the characteristic information is set.

In a case where it is determined that the vehicle has approached an area for which characteristic information recorded on the characteristic-information setting map is set, the processing proceeds to step S406.

Meanwhile, in a case where it is determined that the vehicle has not approached an area for which characteristic information recorded on the characteristic-information setting map is set, the processing returns to step S404, and traveling processing according to the travel route is continued.

(Step S406)

In a case where it is determined in step S405 that the vehicle has approached an area for which characteristic information recorded on the characteristic-information setting map is set, the processing proceeds to step S406.

In step S406, the data processing unit of the information processing device selects, from the characteristic-information corresponding display data storage DB, display data corresponding to characteristic information that the vehicle is approaching.

As described above with reference to FIG. 6, in the characteristic-information corresponding display data storage DB, display data associated with various pieces of characteristic information are recorded.

In step S406, the data processing unit of the information processing device selects, from the characteristic-information corresponding display data storage DB, display data corresponding to characteristic information that the vehicle is approaching.

(Step S407)

Next, in step S407, the data processing unit of the information processing device generates an AR image obtained by superimposing display data acquired from the characteristic-information corresponding display data storage DB in step S406 on an image captured by the external camera, that is, a real object image obtained by capturing an image of external scenery, and then outputs the AR image to the display unit.

That is, the AR image is output to the display unit inside the vehicle described with reference to FIG. 2.

Moreover, travel control in accordance with display data display is executed on the basis of the travel pattern information generated in step S403. For example, travel control for low-speed travel or temporary stop is executed.

The display unit inside the vehicle displays an actual image of the external scenery captured by the camera outside the vehicle, and the information processing device generates and displays AR image display data obtained by superimposing a virtual object such as display data selected from the characteristic-information corresponding display data storage DB, that is image data of a whale for example, on the actual image including the real object.

Note that processing of displaying the display data acquired from the characteristic-information corresponding display data storage DB ends after the vehicle passes through the area for which the characteristic information is set. This end timing is performed according to a predetermined algorithm. For example, erasure processing is executed according to a predetermined algorithm to perform erasure 10 seconds after the vehicle passes the area for which the characteristic information is set, or to perform erasure after traveling 10 also from the area for which the characteristic information is set.

(Step S408)

Finally, in step S408, the information processing device determines whether or not the vehicle has arrived at the destination.

In a case where the vehicle has not arrived at the destination, the processing returns to step S404, the vehicle continues traveling along the travel route, and the processing in step S405 and subsequent steps is repeatedly executed.

In a case where the vehicle arrives at the destination, the processing ends.

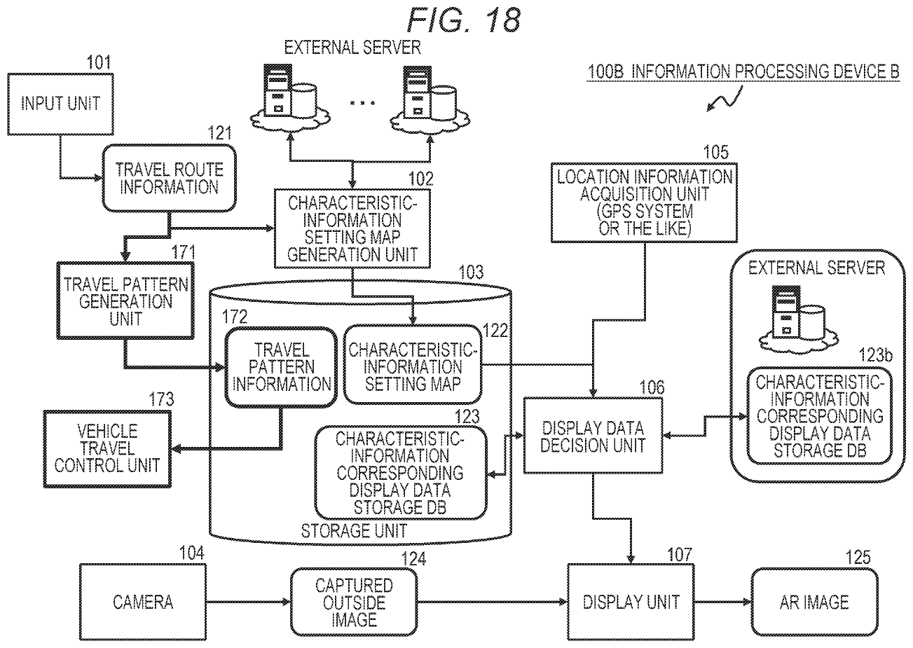

Next, a configuration example of an information processing device B100B that executes Example 4 will be described with reference to FIG. 18.

The information processing device B100B illustrated in FIG. 18 is mounted inside the vehicle 10 described with reference to FIGS. 1 and 2, for example. Alternatively, the information processing device 100 may be provided in an external device capable of communicating with the vehicle 10 via a communication unit.

The information processing device B100B illustrated in FIG. 18 has a configuration based on the information processing device 100 in Example 1 described above with reference to FIG. 8.

As illustrated in FIG. 18, the information processing device B100B has an input unit 101, the characteristic-information setting map generation unit 102, a storage unit 103, a camera 104, a location information acquisition unit (GPS system or the like) 105, the display data decision unit 106, and a display unit 107. These configurations are similar to the configurations of the information processing device 100 of Example 1 described above with reference to FIG. 8.

In addition to these configurations, the information processing device B100B illustrated in FIG. 18 has a travel pattern generation unit 171 and a vehicle travel control unit 173.

The input unit 101 is, for example, an input unit with which the user performs processing of inputting a departure point and a destination point, inputting a travel route, or the like.

Travel route information 121 input via the input unit 101 is input to the characteristic-information setting map generation unit 102.

The characteristic-information setting map generation unit 102 generates a characteristic-information setting map in which various pieces of characteristic information are set at each location along the travel route of the input travel route information 121.

The characteristic-information setting map is a map described above with reference to FIG. 3, and is a map in which various pieces of characteristic information regarding a travel route from (S) Departure point to (E) Destination point of the vehicle are recorded.

A characteristic-information setting map 122 generated by the characteristic-information setting map generation unit 102 is stored in the storage unit 103. Note that the characteristic-information setting map 122 may be stored in the external server.

The camera 104 is a camera that captures an image of outside of the vehicle 10, that is, scenery. A captured outside image 124 captured by the camera 104 is displayed on the display unit 107.

The display unit 107 is a display unit inside the vehicle, that is, a display unit such as the front display unit 21, the left-side surface display unit 22, or the right-side surface display unit 23 provided inside the vehicle described above with reference to FIG. 2.

The location information acquisition unit (GPS system or the like) 105 executes communication with, for example, a GPS satellite or the like to analyze a current location of the vehicle.

The analyzed location information is input to the display data decision unit 106.

The display data decision unit 106 inputs current location information of the vehicle from the location information acquisition unit (GPS system or the like) 105.

By utilizing the location information, the display data decision unit 106 determines whether or not the vehicle has approached the area for which the characteristic information recorded on the characteristic-information setting map 122 acquired from the storage unit 103 is set. For example, it is determined whether or not the vehicle has approached within a predetermined distance (10 m or the like) of the area for which the characteristic information is set.

In a case where the vehicle has approached the area for which characteristic information recorded on the characteristic-information setting map 122 is set, the display data decision unit 106 selects, from a characteristic-information corresponding display data storage DB 123 stored in the storage unit 103, display data corresponding to the characteristic information that the vehicle is approaching.

Note that the display data decision unit 106 may utilize the characteristic-information corresponding display data storage DB 123b held by the external server as illustrated in FIG. 18.

As described above with reference to FIG. 6, in the characteristic-information corresponding display data storage DB, display data associated with various pieces of characteristic information are recorded.

From the characteristic-information corresponding display data storage DB 123, the display data decision unit 106 selects display data corresponding to the characteristic information that the vehicle is approaching.

On the display unit 107 displaying an image captured by the external camera, that is, a captured outside image obtained by capturing an image of external scenery, the display data decision unit 106 superimposes display data acquired from the characteristic-information corresponding display data storage DB 123, and displays the display data.

As a result, an AR image 125 obtained by superimposing the display data (virtual object image) acquired from the characteristic-information corresponding display data storage DB 123 on the captured outside image (real object image) obtained by capturing the image of the external scenery is displayed on the display unit 107 inside the vehicle.

Moreover, the travel pattern generation unit 171 decides a travel pattern in traveling processing according to the travel route of the vehicle. For example, there is generated travel pattern information of temporary stop or low-speed travel in a section in which display data corresponding to the characteristic information is displayed.

The travel pattern generation unit 171 stores the generated travel pattern information 172 in the storage unit 103.

The vehicle travel control unit 173 acquires travel pattern information 172 stored in storage unit 103, and executes travel control for causing the vehicle to travel according to travel pattern information 172.

With this travel control processing, for example, temporary stop or low-speed travel is performed in the display section of the display data corresponding to the characteristic information.

[2-5. (Example 5) Example of performing display information control in which image selected according to characteristic information set in characteristic-information setting map or occupant attribute is output by utilizing characteristic-information setting map corresponding to travel route from departure place to destination, and performing switching control of display data on basis of occupant observation data]

Next, (Example 5) Example of performing display information control in which image selected according to characteristic information set in characteristic-information setting map or occupant attribute is output by utilizing characteristic-information setting map corresponding to travel route from departure place to destination, and performing switching control of display data on basis of occupant observation data will be described.

In Example 5, there is performed display information control for outputting an image selected according to not only characteristic information set in the characteristic-information setting map as in Example 1 described above, but also an occupant attribute. Moreover, in Example 5, switching control of display data is performed on the basis of occupant observation data.

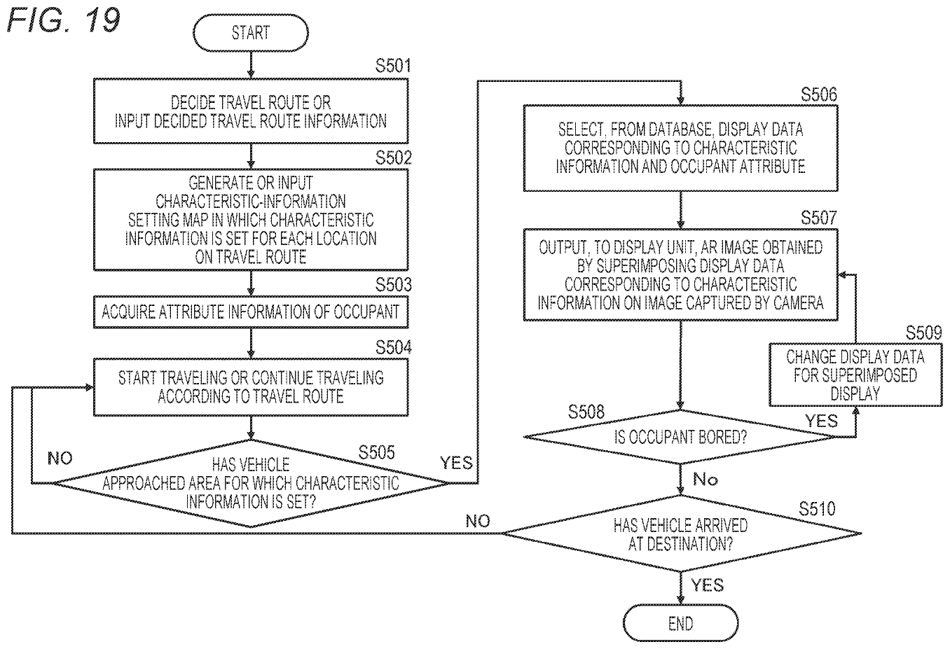

A processing sequence of Example 5 will be described with reference to FIG. 19.

The processing of each step of the flow illustrated in FIG. 19 will be described.

(Step S501)

First, in step S501, the data processing unit of the information processing device decides a travel route of the vehicle or inputs decided travel route information.

For example, a travel route connecting (S) Departure point and (E) Destination point as described above with reference to FIG. 3 is decided.

As described above, (S) Departure point and (E) Destination point are set by the user or manager of the vehicle, and for example, a shortest travel route is decided on the basis of settings for (S) Departure point and (E) Destination point. Alternatively, the user or manager of the vehicle 10 may decide a travel route of the vehicle, and input the decided travel route information.

(Step S502)

Next, in step S502, the data processing unit of the information processing device generates or inputs a characteristic-information setting map in which characteristic information is set for each location on the travel route decided in step S501.

The characteristic-information setting map is a map described above with reference to FIG. 3, and is a map in which various pieces of characteristic information regarding a travel route from (S) Departure point to (E) Destination point of the vehicle are recorded.

In step S502, the data processing unit of the information processing device executes processing of generating a characteristic-information setting map as illustrated in FIG. 3 or processing of acquiring a characteristic-information setting map from outside.

In a case of generating a characteristic-information setting map, as described above, the information processing device utilizes, for example, the following information.

(1) Characteristic information acquired by traveling processing of camera-mounted vehicle executed in advance and stored in storage unit of information processing device or external server

(2) Real-time traffic information provided by external traffic-information provision server

(3) Real-time characteristic information (event information or the like) provided by external event-information provision server

Note that, for example, in a case where a latest characteristic-information setting map is stored in an external device such as an external server, the characteristic-information setting map may be acquired.

(Step S503)

Next, in step S503, the data processing unit of the information processing device acquires attribute information of an occupant in the vehicle.

For example, the number of occupants, gender, age structure, hobby, boarding history, or an occupant state that is, for example, a state of the occupant such as paying attention to the display unit, not looking at the display unit, occupants being engrossed in a conversation, or the like is also analyzed and acquired.

These pieces of occupant attribute information are acquired by, for example, processing of analyzing a captured image of an occupant or processing of analyzing data input by an occupant.

(Step S504)

Next, in step S504, the data processing unit of the information processing device starts traveling according to the travel route decided in step S501.

(Step S505)

Next, in step S505, the data processing unit of the information processing device determines whether or not the vehicle has approached an area for which characteristic information recorded on the characteristic-information setting map generated or acquired in step S502 is set. For example, it is determined whether or not the vehicle has approached within a predetermined distance (10 m or the like) of the area for which the characteristic information is set.

In a case where it is determined that the vehicle has approached an area for which characteristic information recorded on the characteristic-information setting map is set, the processing proceeds to step S506.

Meanwhile, in a case where it is determined that the vehicle has not approached an area for which characteristic information recorded on the characteristic-information setting map is set, the processing returns to step S504, and traveling processing according to the travel route is continued.

(Step S506)

In a case where it is determined in step S505 that the vehicle has approached an area for which characteristic information recorded on the characteristic-information setting map is set, the processing proceeds to step S506.

In step S506, the data processing unit of the information processing device selects, from the characteristic-information corresponding display data storage DB, display data corresponding to characteristic information that the vehicle is approaching.

Note that, in the characteristic-information corresponding display data storage DB utilized in this Example, display data associated with characteristic information and with an occupant attribute is recorded.

For example, the following corresponding data is recorded.

(1) Example of DB-recorded corresponding data 1

(1a) Characteristic information=Park under open sky

(1b) Occupant attribute=Child aged 10 or younger

(1c) Display data=Whale animation

(2) Example of DB-recorded corresponding data 2

(2a) Characteristic information=Park under open sky

(2b) Occupant attribute=Adult

(2c) Display data=Actual moving image of whale

Thus, in the characteristic-information corresponding display data storage DB utilized in Example 5, not only characteristic information but also display data corresponding to an occupant attribute are recorded, and optimum content corresponding to an occupant is displayed.

(Step S507)

Next, in step S507, the data processing unit of the information processing device generates an AR image obtained by superimposing display data acquired from the characteristic-information corresponding display data storage DB in step S506 on an image captured by the external camera, that is, a real object image obtained by capturing an image of external scenery, and then outputs the AR image to the display unit.

That is, the AR image is output to the display unit inside the vehicle described with reference to FIG. 2.

The display unit inside the vehicle displays an actual image of the external scenery captured by the camera outside the vehicle, and the information processing device generates and displays AR image display data obtained by superimposing a virtual object such as display data selected from the characteristic-information corresponding display data storage DB, that is image data of a whale for example, on the actual image including the real object.

(Step S508)

Next, in step S508, the data processing unit of the information processing device determines a state of the occupant, specifically, whether the occupant is paying attention to the image on the display unit in the vehicle or is bored without paying attention.

This determination processing is executed on the basis of analysis of an image captured by an in-vehicle camera.

In a case where it is determined that the occupant is bored, the processing proceeds to step S509.

In a case where it is determined that the occupant is not bored, current display data is displayed as is. Note that processing of displaying the display data acquired from the characteristic-information corresponding display data storage DB ends after the vehicle passes through the area for which the characteristic information is set. This end timing is performed according to a predetermined algorithm. For example, erasure processing is executed according to a predetermined algorithm to perform erasure 10 seconds after the vehicle passes the area for which the characteristic information is set, or to perform erasure after traveling 10 also from the area for which the characteristic information is set.

(Step S509)

In a case where it is determined in step S508 that the occupant is bored, the processing proceeds to step S509.

In this case, the data processing unit of the information processing device executes switching of the display data in step S509.

Note that, also in this switching processing, display data corresponding to the occupant attribute is selected from the DB and displayed.

(Step S510)

Finally, in step S510, the information processing device determines whether or not the vehicle has arrived at the destination.

In a case where the vehicle has not arrived at the destination, the processing returns to step S504, the vehicle continues traveling along the travel route, and the processing in step S505 and subsequent steps is repeatedly executed.

In a case where the vehicle arrives at the destination, the processing ends.

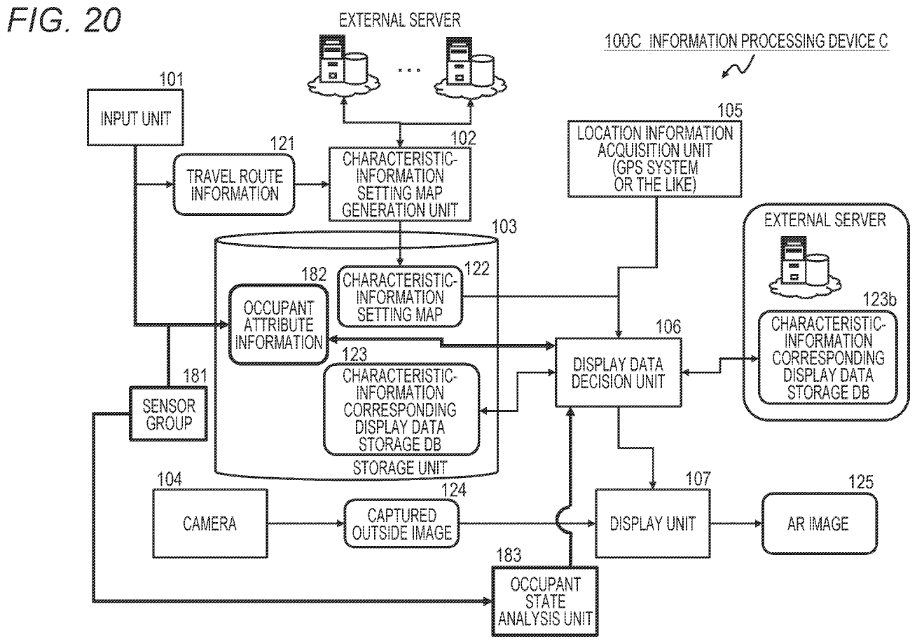

Next, a configuration example of an information processing device C100C that executes Example 5 will be described with reference to FIG. 20.

The information processing device C100C illustrated in FIG. 20 is mounted inside the vehicle 10 described with reference to FIGS. 1 and 2, for example. Alternatively, the information processing device 100 may be provided in an external device capable of communicating with the vehicle 10 via a communication unit.

The information processing device C100C illustrated in FIG. 20 has a configuration based on the information processing device 100 in Example 1 described above with reference to FIG. 8.

As illustrated in FIG. 20, the information processing device C100C has an input unit 101, the characteristic-information setting map generation unit 102, a storage unit 103, a camera 104, a location information acquisition unit (GPS system or the like) 105, the display data decision unit 106, and a display unit 107. These configurations are similar to the configurations of the information processing device 100 of Example 1 described above with reference to FIG. 8.

In addition to these configurations, the information processing device C100C illustrated in FIG. 20 has a sensor group 181 and an occupant state analysis unit 183.

The input unit 101 is, for example, an input unit with which the user performs processing of inputting a departure point and a destination point, inputting a travel route, or the like.

Travel route information 121 input via the input unit 101 is input to the characteristic-information setting map generation unit 102.

Moreover, in Example 5, the input unit 101 is also utilized for processing of inputting occupant attribute information by an occupant or a manager.

The occupant attribute is, for example, the number of occupants, gender, age structure, hobby, boarding history, or the like.

These occupant attributes are generated by input via the input unit 101 and on the basis of analysis information of an in-vehicle camera that constitutes the sensor group 181, and are recorded in the storage unit 103 as occupant attribute information 182.

The characteristic-information setting map generation unit 102 generates a characteristic-information setting map in which various pieces of characteristic information are set at each location along the travel route of the input travel route information 121.

The characteristic-information setting map is a map described above with reference to FIG. 3, and is a map in which various pieces of characteristic information regarding a travel route from (S) Departure point to (E) Destination point of the vehicle are recorded.

A characteristic-information setting map 122 generated by the characteristic-information setting map generation unit 102 is stored in the storage unit 103. Note that the characteristic-information setting map 122 may be stored in the external server.

The camera 104 is a camera that captures an image of outside of the vehicle 10, that is, scenery. A captured outside image 124 captured by the camera 104 is displayed on the display unit 107.

The display unit 107 is a display unit inside the vehicle, that is, a display unit such as the front display unit 21, the left-side surface display unit 22, or the right-side surface display unit 23 provided inside the vehicle described above with reference to FIG. 2.

The location information acquisition unit (GPS system or the like) 105 executes communication with, for example, a GPS satellite or the like to analyze a current location of the vehicle.

The analyzed location information is input to the display data decision unit 106.

The display data decision unit 106 inputs current location information of the vehicle from the location information acquisition unit (GPS system or the like) 105.

By utilizing the location information, the display data decision unit 106 determines whether or not the vehicle has approached the area for which the characteristic information recorded on the characteristic-information setting map 122 acquired from the storage unit 103 is set. For example, it is determined whether or not the vehicle has approached within a predetermined distance (10 m or the like) of the area for which the characteristic information is set.

The display data decision unit 106 further acquires the occupant attribute information 182 from the storage unit 103, and decides display data according to the occupant attribute information.

In a case where the vehicle has approached the area for which characteristic information recorded on the characteristic-information setting map 122 is set, display data is selected, from the characteristic-information corresponding display data storage DB 123 stored in the storage unit 103, on the basis of the characteristic information that the vehicle is approaching and the occupant attribute information.

Note that the display data decision unit 106 may utilize the characteristic-information corresponding display data storage DB 123b held by the external server as illustrated in FIG. 18.

As described above, in the characteristic-information corresponding display data storage DB utilized in this Example, display data associated with characteristic information and with an occupant attribute is recorded.

For example, the following corresponding data is recorded.

(1) Example of DB-recorded corresponding data 1

(1a) Characteristic information=Park under open sky

(1b) Occupant attribute=Child aged 10 or younger

(1c) Display data=Whale animation

(2) Example of DB-recorded corresponding data 2

(2a) Characteristic information=Park under open sky

(2b) Occupant attribute=Adult

(2c) Display data=Actual moving image of whale

Thus, in the characteristic-information corresponding display data storage DB utilized in Example 5, not only characteristic information but also display data corresponding to an occupant attribute are recorded, and the display data decision unit 106 selects and displays optimum content corresponding to the occupant attribute.

On the display unit 107 displaying an image captured by the external camera, that is, a captured outside image obtained by capturing an image of external scenery, the display data decision unit 106 superimposes display data corresponding to the occupant attribute, the display data being acquired from the characteristic-information corresponding display data storage DB 123, and displays the display data.

As a result, an AR image 125 obtained by superimposing the display data (virtual object image) corresponding to the occupant attribute, the display data being acquired from the characteristic-information corresponding display data storage DB 123, on the captured outside image (real object image) obtained by capturing the image of the external scenery is displayed on the display unit 107 inside the vehicle.

Moreover, the occupant state analysis unit 183 determines a state of the occupant, specifically, whether the occupant is paying attention to the image on the display unit in the vehicle or is bored without paying attention.

This determination processing is executed on the basis of analysis of an image captured by an in-vehicle camera.

Determination information as to whether or not the occupant is bored is input to the display data decision unit 106.

When determination information that the occupant is bored is input to the display data decision unit 106, the display data decision unit 106 performs processing of switching the current display data.

The processing of switching the display data is also executed by selecting, from the characteristic-information corresponding display data storage DB, display data corresponding to the occupant attribute.

Thus, Example 5 has a configuration in which display data is selected on the basis of an attribute of an occupant, and the display data is switched according to an occupant state during the data display, by which data display that does not bore the occupant can be performed.

Up to this point, five Examples of the information processing device according to the present disclosure, that is, the following five Examples, have been described.

(Example 1) Example of performing display information control in which image corresponding to characteristic information set in characteristic-information setting map is output by utilizing characteristic-information setting map corresponding to travel route from departure place to destination

(Example 2) Example of performing, during travel on travel route from departure place to destination, display information control in which characteristic scene is extracted from image captured by camera that captures image of outside of vehicle, and image corresponding to extracted characteristic scene is output

(Example 3) Example of performing, during travel on travel route from departure place to destination, display information control in which display data is decided on basis of detection information from various kinds of sensors, such as camera, and other acquired information, and decided display data is output

(Example 4) Example of performing display information control in which image corresponding to characteristic information set in characteristic-information setting map is output by utilizing characteristic-information setting map corresponding to travel route from departure place to destination, and performing travel control of vehicle according to characteristic information set in characteristic-information setting map

(Example 5) Example of performing display information control in which image selected according to characteristic information set in characteristic-information setting map or occupant attribute is output by utilizing characteristic-information setting map corresponding to travel route from departure place to destination, and performing switching control of display data on basis of occupant observation data

Each of these Examples can be executed individually, and can also be executed as an arbitrary combination of a plurality of Examples.

For example, the above-described (Example 1) and (Example 2) may be executed in parallel.

In this case, the information processing device is configured as a device having a configuration in which the configuration of Example 1 described with reference to FIG. 8 and the configuration of Example 2 illustrated in FIG. 11 are combined.

In addition, a configuration in which an arbitrary combination of a plurality of Examples 1 to 5 is also possible.

[3. Configuration examples of information processing device and information processing system]

Although processing executed by the information processing device according to the present disclosure has been described, as described above, the information processing device may be configured in a mobile device such as a vehicle, or may be configured in a device such as an external server capable of communicating with a display device of the vehicle.

Furthermore, part of the processing executed in each of the above-described Examples may be executed by an information processing device in the vehicle, or may be executed by an external device.

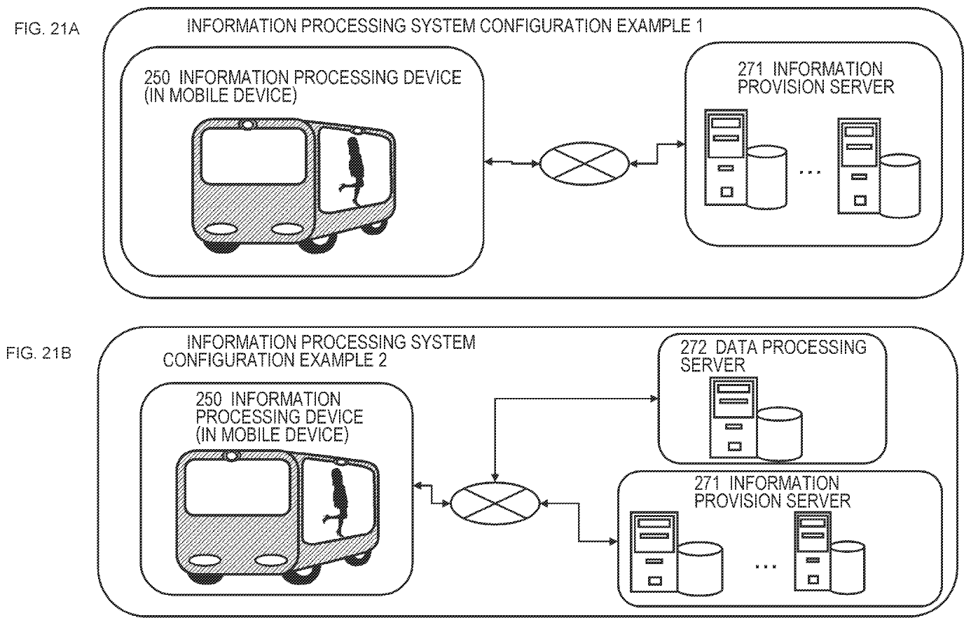

FIG. 21 illustrates a configuration example of an information processing system in a case where processing according to each of the above-described Examples is performed.

FIG. 21 (1) Information processing system configuration example 1 is a configuration example in which processing according to each of the above-described Examples is executed by an information processing device in the vehicle 10.

An information processing device 250 in the vehicle 10 acquires information from an external server 271 in a case of acquiring data required for processing executed in the information processing device 250, that is for example, road information required for processing of generating a travel route setting characteristic-information setting map, characteristic information, data to be displayed on the display unit, or the like.

Data processing to which the acquisition information is applied, data display control, and the like are executed in the information processing device 250 in the vehicle.

Meanwhile, FIG. 21 (2) Information processing system configuration example 2 is an example of a system having a configuration in which processing according to each of the above-described Examples is executed in the information processing device 250 in the vehicle, and in a data processing server 272 capable of communicating with the information processing device 250.

For example, the data processing server 272 may be configured to execute part of processing, such as processing of generating a characteristic-information setting map, described in the above-described Examples.

The information processing device 250 in the vehicle or the data processing server 272 acquires information from the external server 271 in a case of acquiring road information, characteristic information, data to be displayed on the display unit, or the like.

Furthermore, data described as to be stored in the storage unit of the information processing device in each of Examples may be stored in an external server such as the data processing server 272, and may be acquired by the information processing device 250 in the vehicle 10 as necessary.

Note that function division of functions of the information processing device 250 in the vehicle 10 and functions of a server can be set in various different manners, and one function can be executed both in the information processing device 250 and the server.

[4. Hardware configuration example of information processing device]

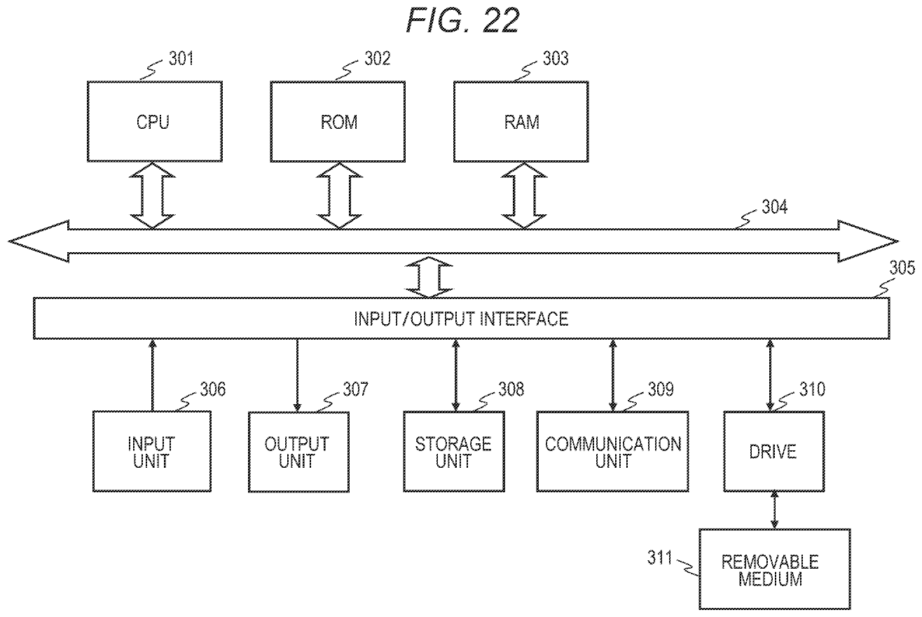

Next, a hardware configuration example of the information processing device will be described with reference to FIG. 22.

A hardware to be described with reference to FIG. 22 is a configuration example of a hardware of an information processing device that executes each of Examples 1 to 5, and is also an example of a hardware configuration of each server illustrated in FIG. 21.

A central processing unit (CPU) 301 functions as a data processing unit that executes various kinds of processing according to a program stored in a read only memory (ROM) 302 or a storage unit 308. For example, processing described in above-described Examples is executed. A random access memory (RAM) 303 stores a program, data, or the like executed by the CPU 301. The CPU 301, the ROM 302, and the RAM 303 are mutually connected by a bus 304.

The CPU 301 is connected to an input/output interface 305 via the bus 304, and the input/output interface 305 is connected to an input unit 306 including various kinds of switches, a keyboard, a touch panel, a mouse, a microphone, and a situation data acquisition unit including a sensor, a camera, a GPS, or the like, and to an output unit 307 including a display, a speaker, or the like.

Note that, in a case of an information processing device provided in the vehicle 10, the input unit 306 includes a camera, a microphone, and various kinds of sensors.

Furthermore, in a case of an information processing device provided in the vehicle 10, the output unit 307 includes a display unit and an audio output unit (speaker).

The CPU 301 inputs a command, situation data, or the like input from the input unit 306, executes various kinds of processing, and outputs a processing result to, for example, the output unit 307.

The storage unit 308 connected to the input/output interface 305 includes, for example, a hard disk or the like, and stores a program executed by the CPU 301 or various kinds of data. A communication unit 309 functions as a transmission/reception unit for data communication via a network such as the Internet or a local area network, and communicates with an external device.

A drive 310 connected to the input/output interface 305 drives a removable medium 311 such as a magnetic disk, an optical disc, a magneto-optical disk, or a semiconductor memory such as a memory card, and records or reads data.

[5. Conclusion of Configuration of Present Disclosure]

Hereinabove, the embodiment according to the present disclosure have been described in detail with reference to the specific embodiment. However, it is obvious that those skilled in the art may make modifications or substitutions to the embodiment without departing from the scope of the present disclosure. That is to say, the present invention has been disclosed in a form of exemplification, and should not be interpreted to be limited. In order to determine the scope of the present disclosure, the claims should be taken into consideration.

Note that the technology disclosed in the present specification can have the following configurations.

(1) An information processing device including

a data processing unit that executes display control of data output to a display unit provided inside a mobile device,

in which the data processing unit acquires characteristic information while the mobile device is traveling, and decides, on the basis of the acquired characteristic information, display data to be output to the display unit.

(2) The information processing device according to (1),

in which the data processing unit selects, from a characteristic-information corresponding display data storage database in which data of correspondence between various pieces of characteristic information and display data are recorded, display data recorded corresponding to the acquired characteristic information, and outputs the selected display data to the display unit.

(3) The information processing device according to (1) or (2),

in which the data processing unit superimposes display data decided on the basis of the characteristic information on an image captured by a camera mounted on the mobile device, and displays the display data.

(4) The information processing device according to any one of (1) to (3),

in which the data processing unit

generates an augmented reality (AR) image obtained by superimposing a virtual object image that is display data decided on the basis of the characteristic information, on a real object image that is an image captured by a camera mounted on the mobile device, and

outputs the AR image to the display unit.

(5) The information processing device according to any one of (1) to (4),

in which the data processing unit refers to a characteristic-information setting map in which characteristic information regarding a travel route of the mobile device is recorded, and

in a case where the mobile device approaches an area of which characteristic information is recorded on the characteristic-information setting map, decides, on the basis of characteristic information of the area, display data to be output to the display unit.

(6) The information processing device according to any one of (1) to (5),

in which the data processing unit detects a characteristic scene from an image captured by a camera on a travel route of the mobile device, and decides, on the basis of the detected characteristic scene, display data to be output to the display unit.

(7) The information processing device according to (6),

in which the data processing unit

extracts a difference between an image captured on a travel route of the mobile device by a camera and averaged image data based on an image captured in past that is generated in advance, and

detects a characteristic scene on the basis of the extracted difference data.

(8) The information processing device according to (7) ,

in which the data processing unit generates, as the averaged image data, an averaged 3D map that is averaged data of a 3D map generated by simultaneous localization and mapping (SLAM) processing, and stores the averaged 3D map in a storage unit, and

the data processing unit extracts a difference between an image captured by a camera on a travel route of the mobile device and the averaged 3D map stored in a storage unit, and detects a characteristic scene on the basis of the extracted difference data.

(9) The information processing device according to any one of (1) to (8),

in which the data processing unit detects characteristic information from information acquired on a travel route of the mobile device by a sensor, and decides, on the basis of the detected characteristic information, display data to be output to the display unit.

(10) The information processing device according to any one of (1) to (9),

in which the data processing unit detects characteristic information from information acquired from an external device on a travel route of the mobile device, and decides, on the basis of the detected characteristic information, display data to be output to the display unit.

(11) The information processing device according to any one of (1) to (10),

in which the data processing unit detects characteristic information from occupant information acquired on a travel route of the mobile device, and decides, on the basis of the detected characteristic information, display data to be output to the display unit.

(12) The information processing device according to any one of (1) to (11),

in which the data processing unit

acquires characteristic information while the mobile device is traveling, decides, on the basis of the acquired characteristic information, display data to be output to the display unit, and

executes travel control of the mobile device on the basis of the acquired characteristic information.

(13) The information processing device according to any one of (1) to (12),

in which the data processing unit executes processing of analyzing a state of an occupant in the mobile device and deciding, on the basis of a result of the analysis, display data to be output to the display unit.

(14) The information processing device according to any one of (1) to (13),

in which the data processing unit executes processing of analyzing a state of an occupant in the mobile device and changing, on the basis of a result of the analysis, display data to be output to the display unit.

(15) An information processing method executed in an information processing device,

in which the information processing device includes a data processing unit that executes display control of data output to a display unit provided inside a mobile device, and

the data processing unit acquires characteristic information while the mobile device is traveling, and decides, on the basis of the acquired characteristic information, display data to be output to the display unit.

(16) A program that causes information processing to be executed in an information processing device,

in which the information processing device includes a data processing unit that executes display control of data output to a display unit provided inside a mobile device, and

the program causes the data processing unit to acquire characteristic information while the mobile device is traveling and to decide, on the basis of the acquired characteristic information, display data to be output to the display unit.

Furthermore, the series of processing described in the specification can be executed by hardware, software, or a combined configuration of both. In a case where processing is executed by software, it is possible to install a program in which a processing sequence is recorded, on a memory in a computer incorporated in dedicated hardware and execute the program, or it is possible to install and execute the program on a general-purpose personal computer that is capable of executing various kinds of processing. For example, the program can be previously recorded on a recording medium. In addition to installation from the recording medium to the computer, the program can be received via a network such as a local area network (LAN) or the Internet and installed on a recording medium such as a built-in hard disk.

Note that the various kinds of processing described in the specification may be executed not only in time series according to the description but also in parallel or individually, according to processing capability of a device that executes the processing, or as necessary. Furthermore, in the present specification, a system is a logical set configuration of a plurality of devices, and is not limited to a system in which devices of respective configurations are in the same housing.

### INDUSTRIAL APPLICABILITY

As described above, according to a configuration of an embodiment of the present disclosure, a configuration is achieved in which display data selected on the basis of characteristic information acquired while a vehicle is traveling is displayed on a display unit inside the vehicle.

Specifically, for example, the configuration has a data processing unit that executes display control of data output to the display unit provided inside the mobile device. The data processing unit acquires characteristic information while the mobile device is traveling, and decides, on the basis of the acquired characteristic information, display data to be output to the display unit. The data processing unit selects display data recorded corresponding to the acquired characteristic information from a characteristic-information corresponding display data storage database, generates an AR image obtained by superimposing the selected display data on a real object image that is an image captured by a camera mounted on the mobile device, and outputs the AR image to the display unit.

With this configuration, a configuration is achieved in which display data selected on the basis of characteristic information acquired while a vehicle is traveling is displayed on a display unit inside the vehicle.

### REFERENCE SIGNS LIST

10 Vehicle
11 Display unit
12 Camera
21 Front display unit
22 Left-side surface display unit
23 Right-side surface display unit
100 Information processing device
101 Input unit
102 Characteristic-information setting map generation unit
103 Storage unit
104 Camera
105 location information acquisition unit (GPS system or the like)
106 Display data decision unit
107 Display unit
150 Information processing device
151 Camera
152 Characteristic scene extraction unit
153 Storage unit
154 Display data decision unit
155 Display unit
156 SLAM processing execution unit
157 Average value calculation processing execution unit
171 Travel pattern generation unit
173 Vehicle travel control unit
181 Sensor group
183 Occupant state analysis unit
200 Information processing device
201 Camera
202 Sensor group
203 Characteristic information extraction unit
204 Storage unit
205 Display data decision unit
206 Display unit
250 Information processing device
271 Information processing server
272 Data processing server
301 CPU
302 ROM
303 RAM
304 Bus
305 Input/output interface
306 Input unit
307 Output unit
308 Storage unit
309 Communication unit
310 Drive
311 Removable medium

1. An information processing device comprising
a data processing unit that executes display control of data output to a display unit provided inside a mobile device,
wherein the data processing unit acquires characteristic information while the mobile device is traveling, and decides, on a basis of the acquired characteristic information, display data to be output to the display unit.

2. The information processing device according to claim 1,
wherein the data processing unit selects, from a characteristic-information corresponding display data storage database in which data of correspondence between various pieces of characteristic information and display data are recorded, display data recorded corresponding to the acquired characteristic information, and outputs the selected display data to the display unit.

3. The information processing device according to claim 1,
wherein the data processing unit superimposes display data decided on a basis of the characteristic information on an image captured by a camera mounted on the mobile device, and displays the display data.

4. The information processing device according to claim 1,
wherein the data processing unit
generates an augmented reality (AR) image obtained by superimposing a virtual object image that is display data decided on a basis of the characteristic information, on a real object image that is an image captured by a camera mounted on the mobile device, and
outputs the AR image to the display unit.

5. The information processing device according to claim 1,
wherein the data processing unit refers to a characteristic-information setting map in which characteristic information regarding a travel route of the mobile device is recorded, and
in a case where the mobile device approaches an area of which characteristic information is recorded on the characteristic-information setting map, decides, on a basis of characteristic information of the area, display data to be output to the display unit.

6. The information processing device according to claim 1,
wherein the data processing unit detects a characteristic scene from an image captured by a camera on a travel route of the mobile device, and decides, on a basis of the detected characteristic scene, display data to be output to the display unit.

7. The information processing device according to claim 6,
wherein the data processing unit
extracts a difference between an image captured on a travel route of the mobile device by a camera and averaged image data based on an image captured in past that is generated in advance, and
detects a characteristic scene on a basis of the extracted difference data.

8. The information processing device according to claim 7,
wherein the data processing unit generates, as the averaged image data, an averaged 3D map that is averaged data of a 3D map generated by simultaneous localization and mapping (SLAM) processing, and stores the averaged 3D map in a storage unit, and
the data processing unit extracts a difference between an image captured by a camera on a travel route of the mobile device and the averaged 3D map stored in a storage unit, and detects a characteristic scene on a basis of the extracted difference data.

9. The information processing device according to claim 1,
wherein the data processing unit detects characteristic information from information acquired on a travel route of the mobile device by a sensor, and decides, on a basis of the detected characteristic information, display data to be output to the display unit.

10. The information processing device according to claim 1,
wherein the data processing unit detects characteristic information from information acquired from an external device on a travel route of the mobile device, and decides, on a basis of the detected characteristic information, display data to be output to the display unit.

11. The information processing device according to claim 1,
wherein the data processing unit detects characteristic information from occupant information acquired on a travel route of the mobile device, and decides, on a basis of the detected characteristic information, display data to be output to the display unit.

12. The information processing device according to claim 1,
wherein the data processing unit
acquires characteristic information while the mobile device is traveling, decides, on a basis of the acquired characteristic information, display data to be output to the display unit, and
executes travel control of the mobile device on a basis of the acquired characteristic information.

13. The information processing device according to claim 1,
wherein the data processing unit executes processing of analyzing a state of an occupant in the mobile device and deciding, on a basis of a result of the analysis, display data to be output to the display unit.

14. The information processing device according to claim 1,
wherein the data processing unit executes processing of analyzing a state of an occupant in the mobile device and changing, on a basis of a result of the analysis, display data to be output to the display unit.

15. An information processing method executed in an information processing device,
wherein the information processing device includes a data processing unit that executes display control of data output to a display unit provided inside a mobile device, and
the data processing unit acquires characteristic information while the mobile device is traveling, and decides, on a basis of the acquired characteristic information, display data to be output to the display unit.

16. A program that causes information processing to be executed in an information processing device,
wherein the information processing device includes a data processing unit that executes display control of data output to a display unit provided inside a mobile device, and
the program causes the data processing unit to acquire characteristic information while the mobile device is traveling and to decide, on a basis of the acquired characteristic information, display data to be output to the display unit.
